(19) United States
(12) Patent Application Publication
(10) Pub. No.: US 2024/0291848 A1
(43) Pub. Date: Aug. 29, 2024

(54) AUTONOMOUS DISTRIBUTED CYBERSECURITY TESTING

(71) Applicant: NDSU Research Foundation, Fargo, ND (US)

(72) Inventors: Jeremy Straub, Fargo, ND (US); Jack Hance, Fargo, ND (US); Noah Ross, Fargo, ND (US); Jordan Milbrath, Fargo, ND (US); Noah Ritter, Fargo, ND (US); Robert Fedor, Fargo, ND (US)

(21) Appl. No.: 18/582,039

(22) Filed: Feb. 20, 2024

Related U.S. Application Data
(60) Provisional application No. 63/485,665, filed on Feb. 17, 2023.

(51) Int. Cl. H04L 9/40

(52) U.S. Cl. CPC H04L 63/1433

(57) ABSTRACT

A system for autonomous cybersecurity probing includes a scanning module adapted to convert a target computing device or network scan to machine readable form. The scanning module includes an ingest module which processes the scan to create nodes representing the target ports, port status, and vulnerabilities. A command module includes a plurality of nodes representing facts, rules, actions, and verifiers associated with one or more vulnerabilities identified by the scanning module. The command module is configured to determine whether to launch an attack. An attack module is configured to, on receipt of instructions from the command module, assign an attack based on a one of the one or more vulnerabilities. A verifier module is configured to determine success or failure of the assigned attack and to return an indicator of the determined success or failure to the command module. Methods for cybersecurity probing using the described system are provided.

### TECHNICAL FIELD

The presently-disclosed subject matter generally relates to cybersecurity. In particular, certain embodiments of the presently-disclosed subject matter relate to an automated cybersecurity system penetration assessment tool for autonomous security testing and re-testing of computer systems and networks.

### BACKGROUND

Cybersecurity is an ever-changing landscape. The threats of the future are hard to predict and even harder to prepare for. This paper presents work designed to prepare for the cybersecurity landscape of tomorrow by creating a key support capability for an autonomous cybersecurity testing system. This system is designed to test and prepare critical infrastructure for what the future of cyberattacks looks like. It proposes a new type of attack framework that provides precise and granular attack control and higher perception within a set of infected infrastructure. The proposed attack framework is intelligent, supports the fetching and execution of arbitrary attacks, and has a small memory and network footprint. This framework facilitates autonomous rapid penetration testing as well as the evaluation of where detection systems and procedures are underdeveloped and require further improvement in preparation for rapid autonomous cyberattacks.

As the sophistication of hackers and cyberattacks increases, the need for advanced defense techniques has grown as well. One facet of this is being able to prepare for attacks by testing systems through simulated intrusions. Penetration testing has become a standard part of many organizations' cybersecurity programs. It allows the entity to detect vulnerabilities and misconfigurations before attackers can exploit them. Due to the skills required and scope of testing that may be needed for large enterprises, penetration testing can be expensive or may be incomplete.

The goal of this work was to facilitate the testing of the security of large, interconnected systems, reducing cost, and expanding testing coverage. This is achieved through using a distributed attack platform that employs an intelligent control scheme to automate vulnerability detection. This disclosure presents a distributed command mechanism for a system which, when all of the distinct aspects are assembled, will act like a combination of a command and control (C2) system and a botnet.

Complex systems can be difficult to fully assess. The larger a network gets, the more potential routes there may be into that system. Intruders may target the furthest edges of the system that are vulnerable to very specific types of attacks. These types of vulnerabilities could be easily missed during testing. Automated testing allows large systems to be examined more quickly and thoroughly. The proposed system has a node-based architecture which also contributes to the ability to scan networks efficiently. It also provides a realistic simulation of potential complex attacks. If one attack attempt is thwarted, the attacker-in many cases-will not simply stop attacking. A testing system with independent nodes, such as the one proposed herein, allows a realistic persistent threat to be simulated. This will be beneficial for testing infrastructure and similar networks which cannot be fully evaluated without testing multi-homed combined effort and other complex attacks.

To address this and other problems, an Autonomous Networked Testing System (ANTS) distributed command system is described herein which integrates with a Blackboard Architecture-based command system to provide the key capabilities of remote attack triggering and node acquisition. The Blackboard Architecture-based command system provides a centralized, multi-homed decision-making capability that can coordinate multiple different attacks. Similar to a determined real-world attacker, seemingly unrelated vulnerabilities in a system may be exploited by the command system to gain access to a system and attempt to achieve attack objectives. This provides a level of complex testing that helps simulate actual risks to critical infrastructure and other key networked systems that require high security.

This disclosure further describes and evaluates an attack node command system developed for the Blackboard Architecture-based command system. These attack nodes will be installed on target systems and discretely receive instructions to carry out commands. They are intentionally designed to be small, modular, and disposable. For testing, this minimizes their interference with normal network operations. It also increases the simulation's fidelity as they are similarly difficult to detect like many types of malware that might be created for nefarious use. The nodes are easily replicable and replaceable allowing the system to continue to function even if some nodes are detected.

The cybersecurity sensing system disclosed herein takes the concept of penetration testing and automates the process to save on time costs, increase ease-of-use for organizations, and to help increase proactive network defense efforts through automated vulnerability detection and exploitation. The system proposed herein uses a single (non-distributed) blackboard system as the artificial intelligence engine powering the network generation and execution.

### SUMMARY

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clarity of understanding and no unnecessary limitations are to be understood therefrom. In case of conflict, the specification of this document, including definitions, will control.

The presently-disclosed subject matter is directed to a system configured for autonomous testing of computer system and network security vulnerabilities. In embodiments, components of the system include an ingest module configured to scan a computer or network being tested to create a system/network model or logical representation that includes all services and potential attack targets. Another component of the system is a data store of known potential attacks and corresponding software, configurations, and system types the attacks are effective against. From these elements, a computer system/network testing plan is developed and executed, and results are output for analysis. From the output results, test success or failure can be identified and verified. Another advantageous feature of the system for autonomous testing is the ability to add, remove, and modify particular tests without requiring coding changes to the core system.

Advantageously, the system for autonomous vulnerability testing can be used not only for initial vulnerability testing, but also for re-testing to ensure that changes do not re-create the initial vulnerability. The system further advantageously facilitates rapid testing/re-testing of, for example, an entire enterprise IT system to determine if vulnerabilities detected on one networking device, software item, or computer system are present in other instances of a same model or type of networking device, software item, or computer system comprised in the enterprise IT system.

In more detail, the present disclosure provides a system for autonomous vulnerability testing further comprising a cooperating node structure. The cooperating node structure includes a command node which acts as a controller for the system, and stores data as facts and uses collections of rules to make decisions and launch actions.

The described system further includes one or more attack nodes which launch a variety of attacks against the system/network model or logical representation. The attack nodes run a variety of attacks on a computer/network system, either directly against the target or against a related target expected to allow compromise of the ultimate target, as ordered by the command node. In an embodiment, access to a foreign system is established and attack node software is installed. Once the software is installed, it gains access to, e.g., the internet and remains dormant until it receives instructions from the command node. Those commands may be provided via attack scripts (human and machine readable instructions containing attack name, description, options and code to be executed) or attack binaries (machine readable code created by running attack scripts to extract the information needed for attack node operations, compressing it, and storing it as binary data). In embodiments, communication between the command node and attack nodes is one-way, and the attack nodes do not report success or failure. This communication may optionally be via intermediaries.

The reporting feature of the described system is provided by one or more verifier nodes which determine the success or failure of an attack launched by an attack node, i.e., to determine whether a target has been compromised by an attack launched by an attack node. In embodiments, there is no communication between attack nodes and verifier nodes.

In another embodiment, a system for autonomous vulnerability testing comprises integrated modules for performing penetration tests. As shown, the system comprises a scanning module comprising an ingest system, an attack module, a verifier module, and a command module which communicates with a data store. In one embodiment the command module is a Blackboard Architecture-based module.

The scanning module is adapted to configure a network scan and convert it to machine-readable form. The ingestion system processes the scan data to create nodes representing network systems, ports, and vulnerabilities.

The attack module is called by the command module and provided with a selected vulnerability to be exploited as well as a target IP address for attack. The attack module assigns an attack based on the specified vulnerability, and then assigns an associated attack script which performs an action against the target. Example actions include, without intending any limitation, making changes to a web page on the target's web server, shutting down the target, and others. Once an attack is completed, the attack module exits and the target system can then be verified as compromised or not.

As described above, the verification is accomplished by the verify module. The verify module, when called by a verify node within the command module, is provided a vulnerability and target IP address. The verify module then determines success or failure of the specified attack, and returns an indicator to the command module of attack success or failure. The specific verification method will vary according to the specific attack type. For example, for an attack intended to alter a web page, the verify module determines whether the expected change has been made. For attacks intended to shut down the target, the verify module attempts to ping the target to determine if the target is operational or shut down. Various types of verifiers are contemplated for use, including without intending any limitation triggered, specific date/time, time in the future, and data expiration.

The command module is responsible for making decisions, triggering other module, and integrating the overall system into a whole. In an embodiment, the command module is comprised of a plurality of nodes representing facts, rules, actions, and verifiers associated with vulnerabilities discovered from the scanning module. These nodes determine whether to launch an attack or not.

In an embodiment, the scanning module gathers data about a network or computer being assessed. Non-limiting examples of data gathered include the number of hosts, the IP address of each host, the operating system of each host, which ports are open, what services are running on each port, and what version of a service is running. Next, the scanning module generates facts for each host indicative of compromise or not. The status of the generated facts changes each time an attack module runs and is verified as a successful attack/host compromise. Facts are generated for each exploitable vulnerability for each host. Then, the system generates possible actions for each host, i.e, exploits to run that may compromise a selected host. The system then generates verifiers for each action for use in determining success of a run action. the system then connects the generated facts, actions, and verifiers with rules specifying particular actions and verifiers to run on identification of a particular vulnerability.

Next, the network is run. The command module iteratively checks for verifiers that should run and rules that have their pre-conditions satisfied, and runs any actions, rules or verifiers as needed.

### BRIEF DESCRIPTION OF THE DRAWINGS

The presently-disclosed subject matter will be better understood, and features, aspects and advantages other than those set forth above will become apparent when consideration is given to the following detailed description thereof. Such detailed description makes reference to the following drawings, wherein:

FIG. 1 shows a diagram of a potential installation of an automated cybersecurity assessment scanning tool according to the present disclosure.

FIG. 2A shows in flowchart form a first portion of a process for attack file processing and for attack file validity.

FIG. 2B shows in flowchart form a second portion of a process for attack file processing and for attack file validity.

FIG. 3 shows in flowchart form a process for parsing an attack file history by an attack node.

FIG. 4 shows in flowchart form processing of a String type.

FIG. 5 shows in flowchart form processing of a List type.

FIG. 6 shows in flowchart form an attack command parsing.

FIG. 7 shows in flowchart form how an attack node runs a received command.

FIG. 8 illustrates a representative testing environment for the automated cybersecurity assessment scanning tool of this disclosure.

FIG. 9 shows a representative system diagram.

FIG. 10 shows a representative Blackboard Architecture network for triggering exploit launches.

FIG. 11 shows a representative system operations diagram.

FIG. 12 illustrates an embodiment of a network design and configuration.

FIG. 13 illustrates an alternative embodiment of a logical network design and configuration.

FIG. 14 illustrates another alternative embodiment of a logical network design and configuration.

FIG. 15 illustrates yet another alternative embodiment of a logical network design and configuration.

FIG. 16 illustrates yet another alternative embodiment of a logical network design and configuration.

FIG. 17 shows a representative example of scan data from NMap utility.

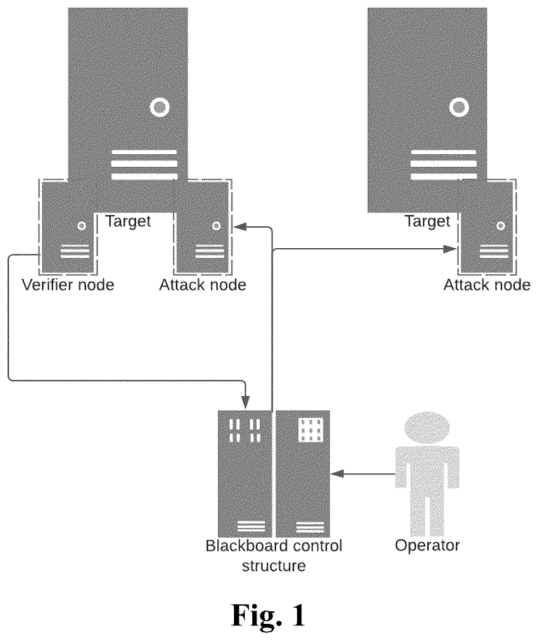

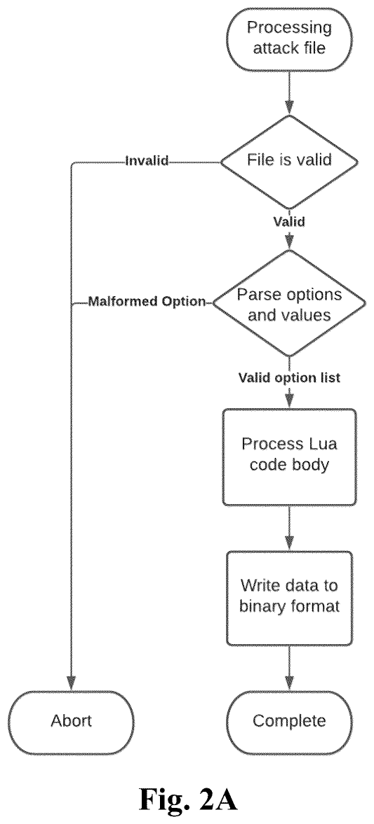

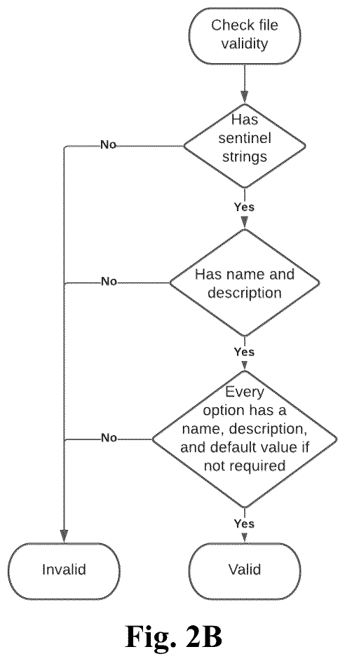

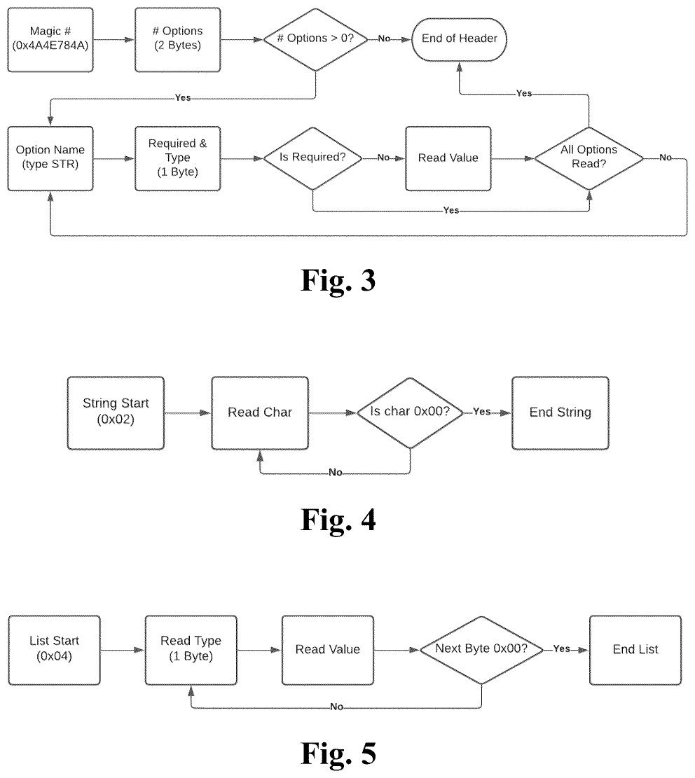

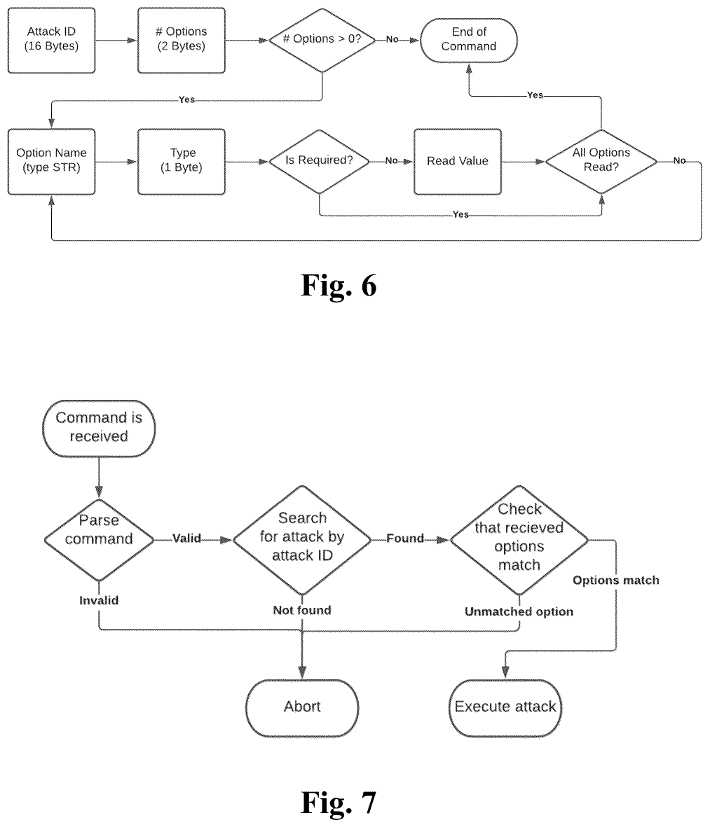

### DETAILED DESCRIPTION

While the terms used herein are believed to be well understood by those of ordinary skill in the art, certain definitions are set forth to facilitate explanation of the presently-disclosed subject matter.

Unless defined otherwise, all technical and scientific terms used herein have the same meaning as is commonly understood by one of skill in the art to which the invention(s) belong.

All patents, patent applications, published applications and publications, databases, websites and other published materials referred to throughout the entire disclosure herein, unless noted otherwise, are incorporated by reference in their entirety.

Where reference is made to a URL or other such identifier or address, it understood that such identifiers can change and particular information on the internet can come and go, but equivalent information can be found by searching the internet. Reference thereto evidences the availability and public dissemination of such information.

Although any methods, devices, and materials similar or equivalent to those described herein can be used in the practice or testing of the presently-disclosed subject matter, representative methods, devices, and materials are described herein.

The present application can “comprise” (open ended) or “consist essentially of” the components of the present invention as well as other ingredients or elements described herein. As used herein, “comprising” is open ended and means the elements recited, or their equivalent in structure or function, plus any other element or elements which are not recited. The terms “having” and “including” are also to be construed as open ended unless the context suggests otherwise.

Following long-standing patent law convention, the terms “a”, “an”, and “the” refer to “one or more” when used in this application, including the claims. Thus, for example, reference to “a node” includes a plurality of such nodes, and so forth.

Unless otherwise indicated, all numbers expressing quantities, properties, and so forth used in the specification and claims are to be understood as being modified in all instances by the term “about.” Accordingly, unless indicated to the contrary, any numerical parameters set forth in this specification and claims are approximations that can vary depending upon the desired properties sought to be obtained by the presently-disclosed subject matter.

It is also understood that any disclosed value is also herein disclosed as “about” that particular value in addition to the value itself.

As used herein, “optional” or “optionally” means that the subsequently described event or circumstance does or does not occur and that the description includes instances where said event or circumstance occurs and instances where it does not. For example, an optionally variant portion means that the portion is variant or non-variant.

In portions of the description embodiments of the disclosed automated cybersecurity testing system are described as being directed to testing of computing system or network vulnerabilities. As will be appreciated, the term “vulnerability” will be understood by the skilled artisan to mean any defect in software, hardware, configuration, or computing system or network aspect that allows, enables, and/or increases the ease and/or speed of gaining access and/or commanding the computing system or network.

The system disclosed herein is based on the Blackboard Architecture and utilizes a simplified modern Blackboard Architecture implementation (Jeremy Straub, 2022). Blackboard Architecture is an early form of XAI and was initially implemented in the Hearsay-II speech understanding system (Erman et al., 1980). Blackboard systems are one way of solving very complex problems. Speech understanding using the Hearsay-II system is one example of using a blackboard system to solve a complex problem. Early Blackboard Architecture systems were designed to simulate a group of human specialists cooperatively working together to solve a problem (Craig, 1988). Blackboard systems are based on the metaphor of multiple experts collaborating using a blackboard. The experts each solve part of the problem and share their information via the blackboard for the other experts to use.

A Blackboard Architecture system is comprised of different knowledge sources representing these experts. At their core, blackboard systems closely resemble expert systems. Expert systems are a subset of artificial intelligence that, in a non-procedural manner, emulates a human specialist solving a problem (Detore & Director, 1989). Expert systems contain a knowledge base, an inference engine, and, sometimes, a user interface (Detore & Director, 1989). Expert system rules map out relationships between the information stored in the knowledge base to provide problem-solving capabilities to the system (Detore & Director, 1989). This parallels how, with the Blackboard Architecture, knowledge sources collaborate to solve a given problem. Blackboard Architecture knowledge sources are triggered by events to provide some form of action including producing more information for the blackboard.

The disclosed system implements cyberattacks to test systems. Cyberattacks typically consist of several different phases. There are different approaches to modeling (Jeremy Straub, 2020) cybersecurity attacks including Lockheed Martin's Cyber Kill Chain (Yadav & Rao, 2015) and the MITRE ATT&CK™ (Yadav & Rao, 2015) frameworks. The MITRE ATT&CK™ framework includes seven phases. These phases are [24, 25]:
Recon: The adversary gains information and forms an attack plan.
Weaponize: The adversary obtains harmful exploits or malware.
Deliver: The adversary sends the harmful exploit or malware.
Exploit: The initial attack is executed.
Control: The adversary repeats other phases.
Execute: The adversary achieves desired objectives.
Maintain: The adversary attempts to maintain control over the system.

The MITRE ATT&CK™ framework also contains the ATT&CK™-based analytics development method (Analytics et al., 2017). This seeks to help detect and identify adversary behavior more accurately. This method contains 7 steps: identify behaviors, acquire data, develop analytics, develop an adversary emulation scenario, emulate threat, investigate attack, and evaluate performance (Analytics et al., 2017).

Lockheed Martin's Cyber Kill Chain is another framework for modeling cyberattacks. This model is very similar to the MITRE ATT&CK™ framework. The seven phases of this framework are: reconnaissance, weaponization, delivery, exploitation, installation, command and control, and actions on objectives (Daimi, 2017). Both frameworks are resented and compared in Table 1. The main difference between these two models is the last three sections of each, which cover similar ideas but are organized differently.

TABLE 1
Comparison of ATT&CK ™ and Cyber Kill
Chain models (Jeremy Straub, 2020).

| ATT&CK | Cyber Kill Chain |
|---|---|
| Recon | Reconnaissance |
| Weaponize | Weaponization |
| Deliver | Delivery |
| Exploit | Exploitation |
| Control | Installation |
| Execute | Command and |
| Maintain | Actions on |

The cybersecurity assessment system presented herein uses four different modules that implement the steps in these frameworks. Most closely mapping to the MITRE ATT&CK™ framework's recon stage and Lockheed Martin's Cyber Kill Chain is the proposed system's scanning module which implements the reconnaissance phase. Each of the other modules implements parts of other phases. The system includes a scanning module, an attack module, a verifier module, and a Blackboard Architecture-based command module. The three other components of the system were designed specifically for use within the Blackboard Architecture-based command module. FIG. 9 depicts the interconnection and interactions of the four system modules.

The command node is the controller of the system. It uses a Blackboard Architecture which stores data as facts and uses collection of rules to make decisions and launch actions, based on the operating environment. The command node communicates with the attack nodes and verifier nodes to send commands and retrieve status information. The system is designed to allow operators to identify a target to the command system and then let it run autonomously to survey the network environment and launch attacks. For single node configurations, due to the large amount of data potentially stored on the Blackboard, it should be hosted in a safe environment. Distributed versions of the system are planned that will remove a single command node as a single point of system failure.

Verifier nodes are used to ascertain whether or not targets have been compromised by attacks. They facilitate assessment of the attack nodes' functionality and are key to updating the command node after an attack, in regards to its success (or not) status. Verifier nodes can assess the machine they are installed on or other machines remotely. This type of node is lightweight and has little functionality other than communications and monitoring capabilities.

Attack nodes' purpose, as is expected, is to run attacks on a given system (either against that computer itself, if it is the target, or another target) as ordered by the command node. Attack nodes are placed by the command node or its supporting systems. The process starts by gaining access to a foreign system and installing the attack node software. Once the attack node software is present, it connects to the internet and then remains dormant while it waits for the command node to contact it with instructions. When instructions are received by the attack node, they are processed to carry out the attack. Communication from the command system is largely one-way, potentially via intermediaries, so the attack nodes do not report back on their successes or failures. Instead, verifiers are used to collect this data.

It is important to note that while they may be working in unison, the verifier nodes and attack nodes do not communicate directly with each other. Both types of nodes have limited functionality and depend on the command node for decision making, thus they perform little decision making on their own and instead respond to commands and events.

Commands for the attack nodes can be provided in two formats: attack scripts and attack binaries. Though the two formats store different amounts of meta information, the functional information in both is the same. Attack scripts are instructions for the nodes and are created in a human and machine-readable format. They contain the name of the attack, its description, attack options, and the uncompressed Lua code to be executed. Binaries are created by running the scripts through a processing application which extracts the information needed for attack node operations, making them largely not human readable because their information is compressed and stored as binary data. The Lua code is also minified to reduce its size and information that is not needed by the nodes, such as the attack name and description, is removed.

The attack scripts use options to specify parameters values for the attack. Each option has a name to identify it. They also have associated data types that inform the parser how to interpret the value in the attack binary. The system understands several types including number, string, data, bool and list (which is comprised of other data types including other lists).

### Attack Node System Design

The attack nodes play a key role in the overall penetration testing system. They are designed to be discretely installed and to then sit dormant while waiting for instructions from either the automated command system or a manual operator. In typical use, the nodes have no ability to communicate back to the system or individual commanding them.

A key design goal was to minimize the size and footprint of the attack nodes while operating on a target system and to reduce network traffic. All of these design choices help reduce the likelihood of node discovery. Thus, a set of standards for their creation and operations has been developed. The attack nodes receive instructions through the network but don't send information back to the controller directly. This helps keep operations hidden; however, it impairs the currency of the controller's information about the current state of the running attacks and the system they are affecting. The developed standards are designed to help attacks execute consistently, reducing the need for feedback data.

Attack nodes are designed to support numerous system types and are, thus, designed to be easily modified and recompiled for new targeted system types. The node code was written in the commonly used language C++, which has compilers created for virtually all potentially targeted systems. Calls to lower-level system functions (which may be different between systems) have been wrapped to allow for easier modification and compilation. The constraints also assist in developing new attacks by providing a standard for how they are presented, reducing variability and making them easier to understand.

Attack scripts are written in a standard format which includes two parts: the attack header and body. The header is human readable, has minimal syntax requirements and contains information about the attack including its name, options, and option meta-information indicating whether they are required and, if not, what their default value is. Headers help human system operators understand what is being selected and actioned and aid the attack nodes in comparing the information supplied to the requirements (included in the header). The attack body is written in standard Lua, allowing for portability and flexibility, as Lua is an interpreted language.

After an attack is developed, it is processed to create an attack binary. This is a smaller file that is sent to the nodes, reducing the network footprint. Extraneous information is removed, such as the attack name and whitespace. The Lua is also minified, while maintaining code functionality. Binaries are stored in memory by the attack node, providing a library of attacks to execute. The space is used efficiently, with most being devoted to the data itself, while still being quickly interpretable.

When an attack binary is received by an attack node, its processing begins with the binary parser checking if the file is valid. It reads the first four bytes of the file, which should be a specific arbitrary number indicating that the file is an attack binary. If the number is not the expected value, the parsing process is aborted, and the binary is discarded. Otherwise, the parsing process continues. Once the attack binary has been verified, the parser reads the number of options that the attack contains, which can be up to 65535 distinct options. The parser then enters a loop where it reads the name, type, and default value (if provided) for each option. The remaining data in the file is a compressed version of the Lua code.

There are five data types used for attack options: NUM, STR, DATA, LIST, and BOOL. NUM is a number type, equivalent to a double-precision floating-point (float64) and is eight bytes in size. STR is a string type, which is a sequence of ASCII characters terminated by a binary zero, with a max length of 128 characters. DATA is an data arbitrary type, it is prefixed by an unsigned eight-byte integer that indicates the number of following bytes. LIST is a list format, that consists of any number of any of the other types (including other lists). List entries do not need to be of homogeneous type. Finally, BOOL is a single byte integer for which any value besides zero represents true, and exactly zero represents false. Each attack has an attack identifier, which is a MD5 hash of the original attack script. This allows attacks to be differentiated by both their body contents and headers, as different default header values can completely change how an attack operates. Attacks are executed by sending a command to the node with information for an existing loaded binary. Attack commands use a similar format to the attack header and are similarly processed for size reduction. The command contains the attack identifier and the options' values.

Once an attack node receives a command, it parses it to verify that it has the binary requested. If so, the node executes the Lua using the supplied options as parameters. The Lua is interpreted and executed through a proprietary library which has been integrated directly into the node software itself. If the binary is not present, the node is unable to process the command further.

Lua was selected for its small size and the ease in which it can be statically compiled into and then executed from a single binary file. Scripts written in the language can also be compressed down quite significantly due to the immense malleability of it. The largest disadvantage of Lua is the fact that it lacks most of the functionality of typical programming languages and custom-built cyber-attack languages. This is most prominently apparent when executing commands on a host system and with networking functionality. A library has been implemented using multiple tables of functions that are loaded before script execution. It aids in executing commands on host systems and retrieving their output. A sockets library is also included providing limited networking functionality.

The system intentionally includes no mechanism to assess whether an attack has been executed successfully as there is no current or planned functionality to respond back to the command node. If confirmation is needed, this can be obtained through external verification of the results of the attack. This could be verifying that an existing post-attack state exists. For example, an exploit that planted a reverse shell on a system could be verified by determining whether a response is received to the specified endpoint. Similarly, a denial-of-service attack's success could be verified via attempting to connect to the targeted server to see if it responds or not. In some cases, verification may not be required, such as in a scenario where many machines are targeted concurrently, making the success of any one of limited importance.

### System Evaluation

This section evaluates the proposed autonomous penetration testing system. First, a real-world attack scenario is used to evaluate the system's performance. Second, the limitations of the system are discussed. Third, the system is compared to other conceptually similar systems. Fourth, metrics that can be used to evaluate the system are discussed and used for evaluation purposes.

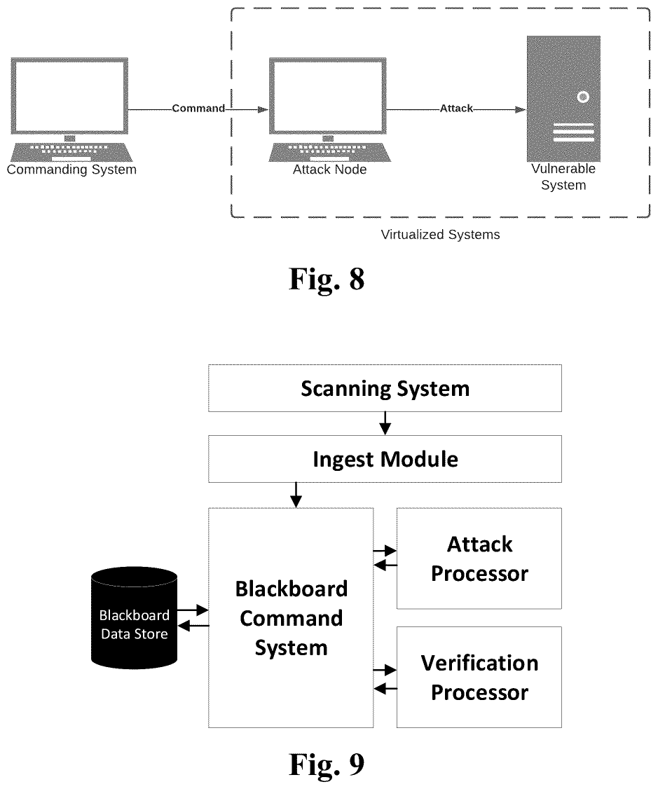

The attack node software has been designed to carry out attacks on both the system hosting the node and on a remote system targeted by the node. FIG. 8 depicts this capability. To validate this capability and demonstrate the efficacy of the system concept and design, several attacks were developed and deployed. One was designed to target the host computer, and two were designed to target a remote computer.

The tests were conducted in a virtualized and sandboxed testing environment. Both the attack node and the vulnerable system that was being targeted were virtual machines. The operating system used for the attack node was Lubuntu 20.04.3 LTS. Aside from the attack node executable being placed onto the system, it was in a completely default install state with no additional packages installed. The attack node was running in 64-bit mode, though a 32-bit system would perform identically. The vulnerable system that served as a target was Metasploitable 2.0.0. A default install of this operating system was used, with no modifications made to it.

Each scenario began with the attack node software already running on the attacking system. This configuration could be the result of an attack against this system which successfully compromised it and used this access to install the attack node software and configure it to automatically start. Alternately, other mechanisms used to distribute malware could be used to reach this state. For some penetration testing scenarios, all systems might start with the system pre-installed in preparation for testing. Each scenario involved a command being sent to the attack system from the command system. The results were then observed.

### Attack Against Attacking System

The first scenario, the attack that targets the attack node itself, was a simple denial of service attack. With the attack node software operating on the computer, a command that shuts down the computer running it was issued by the attack node software. This command is operating system-type specific and the attack was, thus, designed for a Linux based system. It ran successfully on the Lubuntu system, resulting in a denial of service to other prospective system users. In a real-world environment, the command module would need to detect the operating system type and trigger the operating system-appropriate command. This would already be known, in most cases, from the process of compromising the system and placing the attack node; if it was not, it would need to be remotely detected. This attack was designed with no options; thus, the attack command simply identifies the attack to start it, with no additional details being required.

### VSFTPD Attack

The second scenario, which was the first attack that targeted a remote machine, used the well-known VSFTPD v2.3.4 backdoor. This is an exploit that Metasploitable 2.0.0 is intentionally vulnerable to.

The attack is initiated by supplying a command, a remote host IP address, and a remote port which the FTP server is running on. The attack attempts a login with a username ending in “:)” and an intentionally invalid password. It then closes the socket. If the attack is successful, the backdoor opens a console that can be telnetted to on port 6200. The attack then attempts to connect to port 6200 and sends a command (the Linux command “id” was used) to verify the success of this first step. If this is successful, the supplied command option is executed on the remote system. For the purposes of this scenario, a shutdown command was used. This scenario executed successfully against a Metasploitable 2.0.0 system. Success was verified by confirming that the system shut down.

### UnrealIRCD Attack

The third scenario, which was the second attack that targeted a remote machine, used 456 the UnrealIRCD 3.2.8.1 backdoor. This is another exploit that Metasploitable 2.0.0 is intentionally vulnerable to.

The attack is, similarly, initiated by supplying a command, a remote host IP address, and a remote port which the IRC server is running on. The attack is carried out by connecting to the IRC server and sending a string that begins with “AB;” followed by the command to execute. The supplied command was prepended with “AB;” and the attack node then connected to the target IRC server and sent the string. Like with the previous scenario, a shutdown command was used for this scenario as well. This command was also tested against a Metasploitable 2.0.0 system. Success of the attack was verified via confirming that the system shut down.

### Results and Analysis

All three attacks were able to execute successfully in the testing environment. Each achieved arbitrary command execution on either the system running the attack node, or the vulnerable remote target. The two remote attacks are of note, as using the arbitrary command execution capability, they would allow the attack node to upload and execute a copy of itself on the remote system, facilitating the growth of the attack node collection.

The approach provides resiliency and attack capability uptime. A botnet that has control of over 200,000 devices, such as the Mirai botnet, can readily lose 1,000 or more with minimal impact to functionality and capability. Unlike botnets, which may seek to perform large, distributed denial of service (DDOS) attacks, ANTS is intended to operate within a single network (or group of closely interconnected networks) being tested. It thus has somewhat different design goals, though some methods of achieving these goals are shared.

Resiliency through redundancy is also a design goal of ANTS; however, given the different goals of the two systems, it has been approached somewhat differently. Instead of having hundreds or thousands of nodes running at the same time, ANTS uses a smaller and more focused approach. The design, which was described in Section 4, allows the control node to send commands to alternate nodes, if one fails. Nodes are also designed to be able to be quickly created, allowing rapid deployment, if needed. Thus, while not having the same scope or redundancy as botnets like Mirai-nor needing it for penetration testing-the system design facilitates nodes availability to be commanded by the control node for testing.

### Metrics

One key metric by which the proposed system was evaluated is the amount of data that is sent between the control and attack nodes. This is an important consideration, as the time at which this data is being sent is one of the most dangerous parts of the lifecycle of a node. Reducing this metric is very important to reducing the detectability of the system. When operating in TCP mode, ANTS requires a minimum of four packets to send a command to an attack node. Three of these packets are used for the TCP handshake process and the fourth is the data packet that contains the command and its parameters. More data packets may be used when sending large commands or large data parameters. This can be compared to the Mirai botnet. Mirai also connects to a remote node through a TCP handshake. Mirai sends its commands in PSH-ACK packets which the node replies to with an ACK packet. The Mirai network also sends upkeep packets, once a minute, to maintain connections. This means that, in the scenario where both systems use the smallest number of packets possible, Mirai will send five packets and ANTS uses only four. ANTS can further reduce this number if switched to using the UDP protocol instead, where communications would require only a single packet. The size of the packets being sent is important as well. For both systems, the TCP 597 handshake packet contents will be largely the same. For Mirai to execute a DDOS attack, it would send this example command in a packet: UDP 40.81.59.133 30142 20 32 0 10

This would start a DDOS towards the targeted IP at the given port. In order to do a similar attack with ANTS this command could be sent (hexadecimal values are represented by a “\x” with the next two characters being the hex encoded value): 1234567890123456 \x02rhost\x0240.81.59.133rport\x0130142dur\x0120. This is a command that is 54 bytes long. While the ANTS system requires slightly bigger packets, it has the ability to execute larger and more complex attacks than a system like Mirai and thus needs the ability to identify a selection between multiple attack types.

Installation size is another metric that this type of software can be measured by. A design goal of ANTS was to keep its install binary as small as possible while retaining broad functionality. The current ANTS installation is 543 KB, which is quite small and easily portable. However, plans exist to expand this with additional functionality (such as more advanced command parsing features), so this file size is expected to grow. For purposes of comparison, the botnet known as Waldac once had almost 100,000 installed nodes with an install file size of 860 KB. Although ANTS' binary size will continue to increase as functionality is added in the future, it is demonstrably more capable in terms of the attacks that it can run with a file size that is approximately two-thirds of the Waldac example. The ANTS file size is unlikely to grow large enough that it will create installation issues.

As noted above, the disclosed automated cybersecurity assessment system is comprised of four modules that were integrated to automate the process of performing penetration tests. The system includes a scanning module, an attack module, a verifier module, and a Blackboard Architecture-based command module. The three other components of the system were designed specifically for use within the Blackboard Architecture-based command module. FIG. 9 depicts the interconnection and interactions of the four system modules, which are described in greater detail below.

### Scanning Module

The scanning module takes the human-readable output of NMap and converts it into a machine-readable form. NMap was used because it is a widely available tool on Linux distributions and Windows. It also has a large number of options for configuring a network scan and has been studied widely in regard to network reconnaissance activities. Scripts were developed for running it on Linux and Windows. The scripts log the NMap output into a text file where it is read by the NMap parsing library, when called from the system.

An ingestion system is used to process the Nmap scan data to create nodes within the Blackboard Architecture network that represent systems, ports, and vulnerabilities. The parser identifies each host in the NMap output and creates a fact for it in the Blackboard Architecture network. It also adds a port object for each port discovered which is associated with the host object. Information about each port, such as its status as open or closed and the service running on the port, is recorded into the port object.

### Attack Module

The attack module is called by the command system. An initial version of the module, which was used for the experimentation presented herein, was developed as a parameterized wrapper for Metasploit. Notably, the module itself can be easily replaced within the system and Metasploit can be readily replaced within the existing wrapper, if desired.

Metasploit, specifically Metasploit-framework version 6.1.19, was chosen as the starting point for developing the attack module as the intentionally vulnerable Metasploitable2 operating system was used to build vulnerable systems to create the testing environment. The vulnerabilities that exist within Metasploitable2 are easily exploitable by Metasploit. The system was designed with Metasploit handling the exploitation steps and the attack module performing the necessary steps in launching and completing the necessary steps for executing an attack using Metasploit.

When the module is called by the Blackboard Architecture system, the system provides it with a selected vulnerability to exploit and the target IP address based on the data within the Blackboard Architecture network, created by the ingest module. It is also supplied with the IP address of the device which is running the Blackboard Architecture system. The module's operations have three phases. After being called by the Blackboard Architecture system, the module first assigns an attack, based on the vulnerability specified. Next, the module assigns an associated attack script to run against the system. Each attack script has a corresponding attack and has been designed to be run after the Metasploit console has successfully completed the exploit and has root access to the system. The scripts performed an action against the target (that the verify module will later verify the success of). Actions consisted of, for example, making various changes to a webpage on the target's web server or shutting down the target. Finally, the last phase of the attack module was executing the specified attack with the corresponding attack script. This was done through the attack module sending the Metasploit console the necessary directives and attack parameters to complete the desired attack against the target system. Following the success of an exploit the attack module would exit, leaving the target system ready to be successfully verified as compromised.

### Verify Module

The verify module is used to determine whether the target system has been successfully compromised by the attack module. Separately from this work, the Blackboard Architecture system (Jeremy Straub, 2022) was augmented with newly developed verifier node functionality (Jeremy Straub, n.d.) which facilitated the development of the verifier module to verify attack success. The verify module is an application that, when called by a verifier node within the Blackboard Architecture system, is given a vulnerability and target IP address. The verify module then attempts to ascertain the success of the specified attack against the target and returns to the Blackboard Architecture system whether the attack has succeeded or not.

The specific method of verification is dependent on the type of attack that has been executed against the target. After receiving information about the type of attack and the target's IP address, the verify module determines the specific method used for verification. For attacks which make a change on the target's web server, the verify module determines whether the expected change has been made on the target's web server. For attacks which shut down the host, the verify module attempts to ping the target to determine whether the system was shut down or is still operational.

The Blackboard Architecture system supports four types of verifiers: triggered, specific date/time, time in the future, and data expiration. Within the proposed system both triggered verifiers and expiration verifiers were used. Triggered verifiers are unique compared to the other types of verifiers, as they are executed by rules. These verifiers were used to determine whether the system had completed running an attack and should begin running the next attack against the next target. The expiration verifiers were used by the system to determine when to run the verifier module. This was done to, first, prevent the verifier module from running prior to the attack's execution. Second, the expiration verifiers allow for recurring execution once they start, allowing the system to continually run the verifier module if the module indicates that the attack was not yet complete and to eventually stop running the verifier once the attack is indicated as complete.

### Command Module

The proposed system contains a command module which is responsible for making decisions, triggering other modules, and integrating the system together as a whole. This module was designed using a Blackboard Architecture comprised of facts, rules, actions, and verifiers. Facts are values representing information that the system has gathered such as host, port and vulnerability details. Fact status values can be either true or false. Facts also contain an ID and a description field. The description field facilitates explainability. Using this description, the system can provide the user with information describing what decision it made and why. The ID is used to tie the facts together with rules. Rules are logical statements that make decisions based on information stored in facts. Rules take facts as inputs, and the rule is triggered when all facts that are identified as pre-conditions are true. Rules can set fact values, trigger actions, and trigger verifiers. They can also perform a combination of these actions. Actions are triggered by rules to perform a task. In the proposed system, actions are mostly used for running exploits on vulnerabilities. Verifiers are then used to verify if an action was successful.

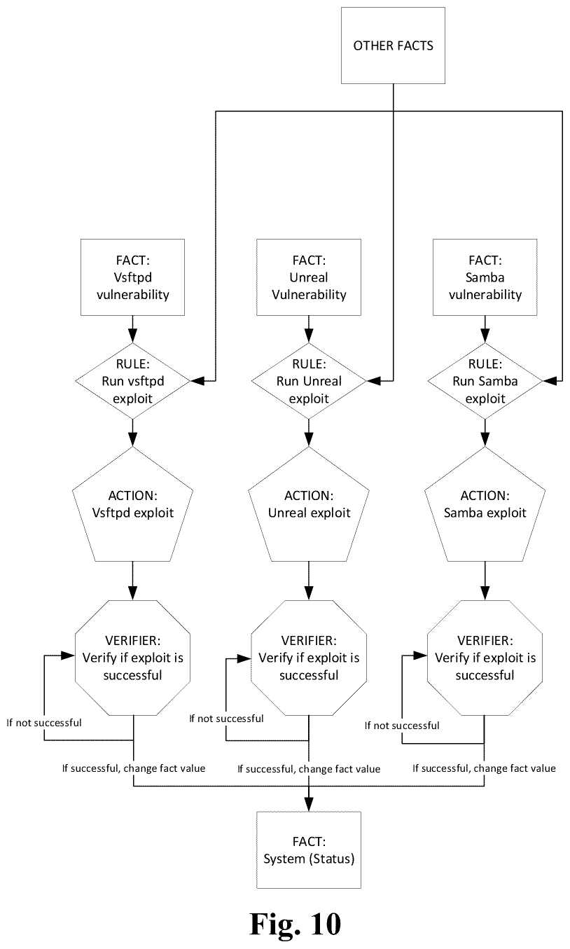

The blackboard network created by the system is comprised of nodes representing facts, rules, actions, and verifiers associated with vulnerabilities discovered from the scanning module. One key area of the Blackboard Architecture network is that the nodes determine whether to launch an attack or not. These key nodes, for one example system, are shown in FIG. 10. Note that, as shown in the figure, an exploit action to launch is selected based on one or more rules having their pre-conditions satisfied. The rules that trigger each exploit make sure that an exploit needs to be run (i.e., they assess the status of the target based on its Blackboard fact status) and whether a given host has an identified vulnerability that can be exploited. If both pre-condition rules are satisfied, the specific exploit is launched and then, after a delay to allow it to complete, its success is checked using a targeted verifier. The verifier updates the status of the system fact to indicate whether it has been compromised by the attack or not.

FIG. 10 is a simplified example of the blackboard network created for a single vulnerable virtual machine. The virtual machine in the example is running Metasploitable2 and contains all three vulnerabilities that are exploitable by the proposed system. The top right of the figure represents other important information used in deciding when and how to attack. In this example, the system creates a fact for each vulnerable service running on the host, along with an associated rule, action, and verifier. Each rule has multiple input facts. One fact represents the specific vulnerability found on the virtual machine. The other input facts represent other information such as if an exploit has run already, if the host is compromised, and if an attack is in progress. This rule is triggered when all input facts are true, which triggers an attack against that vulnerability. There are other rules connected to the other facts. Only one attack can be run at a time because of the attack-in-progress fact. When the attack is run, a verifier checks periodically to see whether it has completed or not. This verifier will continue to check until the attack is finished. When the attack is finished, it will change other facts in the system to account for these changes. One of the other facts represents whether the host has been comprised. This prevents the system from wasting time exploiting multiple vulnerabilities on a compromised host.

### System Operations

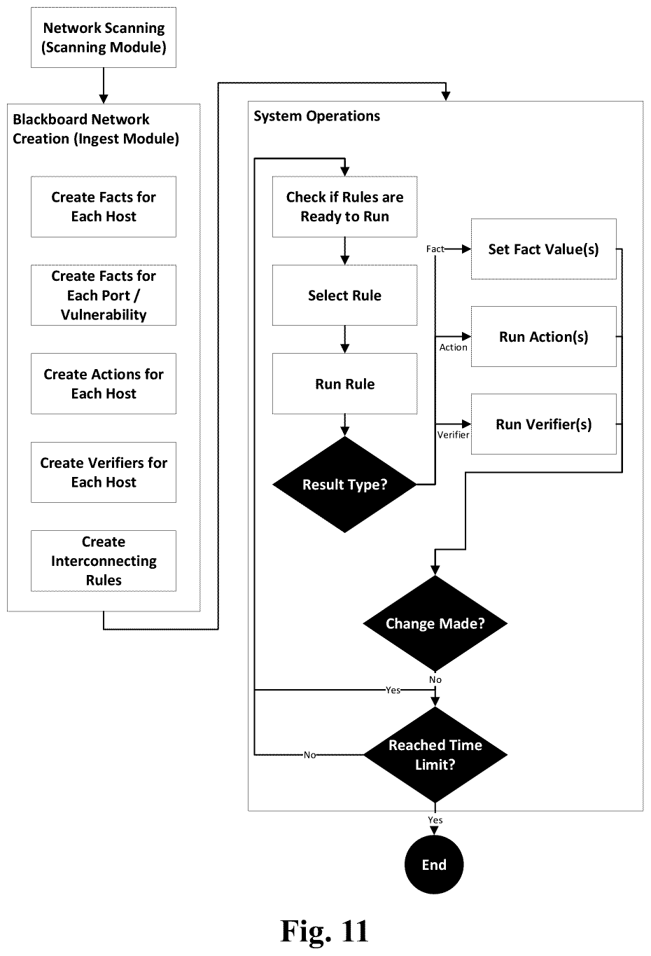

The operations of the disclosed system are depicted in FIG. 11. The system begins by running the scanning module to gather data about the network that it is assessing. Nmap was used by the scanning module, in this step, to collect information regarding the number of hosts, the IP address of each host, the operating system of the host, which ports are open, what services are running on each port, and what version of this service is running. Not all information about the network is completely known after this step due to the limitations of Nmap scanning.

The next step after gathering the network information through the scanning module is to generate facts for each host which indicate that the host is not yet compromised (though potentially, in a real-world application the system could also scan for hosts that an affiliated system already has a command capability for which it can leverage). These facts' status will be changed whenever the attack module runs and is verified as being successful. The system continues by generating facts for each exploitable vulnerability for each host. Next, the system generates possible actions for each host. These actions are the exploits that might be run later to compromise a given host on the network by the attack module. The system then continues by generating verifiers for each action that will be used to check if the action was successful. Next, the system connects all the facts, actions, and verifiers together with rules specifying which attack and verifier to run when a vulnerability is identified. The entire blackboard network is built prior to running any rules.

Finally, the network is run. During this step, the Blackboard Architecture engine iteratively checks for verifiers that should run and rules that have their pre-conditions satisfied. It runs any actions, rules, or verifiers as needed. When an action or verifier is triggered, the command module does not stop checking for rules and verifiers to run. Instead, both modules are run simultaneously. This allows the system to know when an attack is completed rather than estimating when it will complete. Because of the facts generated that specify whether a host is compromised and the associated rules, the Blackboard Architecture system will know when to stop performing additional exploits on each host. There are also facts associated with the number of hosts, so the system will know when every host is either compromised or uncompromisable with the systems' available attacks. This is the termination condition of the system. The created Blackboard Architecture network will be different for every computer network configuration. This means that it will run different actions and create different rules for new computer networks, allowing for adaptability to networks of different sizes and security configurations.

### Testing Environment and Experimental Design

For data collection and evaluation, five networks were designed. Each network also had three unique configurations. Each network consisted of different numbers and types of hosts and each configuration had different vulnerabilities on the vulnerable systems. Tests were run on each individual network configuration to assess the performance of the Blackboard Architecture system under a variety of experimental conditions. The goal of the creation of the networks and configurations was to create models that might be encountered during a real-world penetration test scenario. Using varied network design as well as varying system configurations created unique logical pathways for the Blackboard Architecture system to traverse when determining which target systems contained vulnerabilities and deciding how to exploit them.

### Testing Environment

The blackboard system was tested using a collection of virtual machines to avoid interference between processing and attack time data. One virtual machine host ran the proposed system, while another hosted a group of virtual machines which were the target nodes and the other nodes on the network to test this system on. These computers were physically connected via a wired switched connection. Virtual networking was enabled between the nodes on the target system virtual machine host machine.

The system was tested on five networks of virtual machines, each with three different configurations resulting in different security vulnerabilities. The networks varied by the number of virtual machines in the virtual network, the type of operating systems run on each virtual machine, and the security vulnerabilities on each Metasploitable2 image. The number of machines was between five and fourteen. The operating systems used were Windows 10 20H2, Ubuntu 20.04.3, Ubuntu Server 20.04.3, Metasploitable2, and Android x86-8.1-r6. The different vulnerable software configurations for the Metasplotable2 images were the combinations of vsftpd 2.3.4 running on TCP port 21, Samba smbd 3.0.20 running on TCP ports 139 and 445, and UnrealIRCd running on TCP port 6667. Each of these services is vulnerable to an attack that the proposed system can launch. Metasploitable2 is an intentionally vulnerable operating system that was used to test the efficacy of the system on these vulnerabilities. The Windows, Ubuntu, Ubuntu Server, and Android machines did not have any services that were exploitable by the proposed system. Each of the five network designs is now reviewed.

### First Network

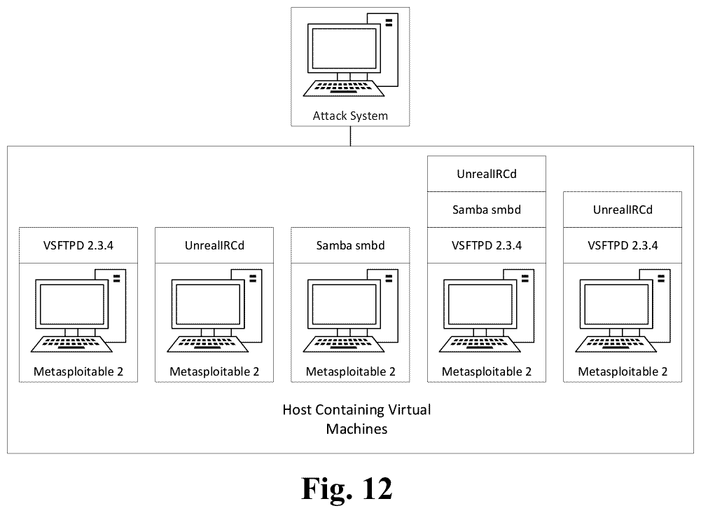

The first network contained five vulnerable virtual machines running Metasploitable2 and no other virtual machines. In the first configuration of this network, the first Metasploitable2 image contained only the vsftpd vulnerability, the second Metasploitable2 image contained only the Unreal vulnerability, the third Metasploitable2 image contained only the Samba vulnerability, the fourth Metasploitable2 image contained all three vulnerabilities, and the fifth Metasploitable2 image contained the vsftpd and Unreal vulnerabilities. In the second configuration of this network, the first three Metasploitable2 images were the same as the first configuration, the fourth Metasploitable2 image contained the vsftpd and Samba vulnerabilities, and the fifth Metasploitable2 image contained the Samba and Unreal vulnerabilities. In the third configuration of this network, the first three Metasploitable2 images were the same as the first and second configurations, the fourth Metasploitable2 image contained the vsftpd and Unreal vulnerabilities, and the fifth Metasploitable2 image contained the Samba and Unreal vulnerabilities. The first configuration of Network 1 is depicted in FIG. 12. Table 2 lists the vulnerabilities for each configuration of network 1.

TABLE 2
Network One Vulnerabilities.

| | | M1 | M2 | M3 | M4 | M5 |
|---|---|---|---|---|---|---|
| Configuration 1 | Vulnerabilities | V | U | S | VUS | VU |
| Configuration 2 | Vulnerabilities | S | V | U | VS | US |
| Configuration 3 | Vulnerabilities | U | S | V | VU | US |

V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

Network 1 was designed to test the efficacy of the proposed system on a fully vulnerable network. Every virtual machine in this network has at least one vulnerability so that there are no non-target distractions for the system. The different configurations test the efficacy of the system on all combinations of vulnerabilities for a single host with the requirement that there must be at least one vulnerability. This simulates the fact that there are many differences in vulnerable networks and configurations in the real world. All three of the configurations have a virtual machine with just one vulnerability of each type along with virtual machines with combinations to test the effectiveness of the system on each vulnerability individually along with combinations of vulnerabilities.

### Second Network

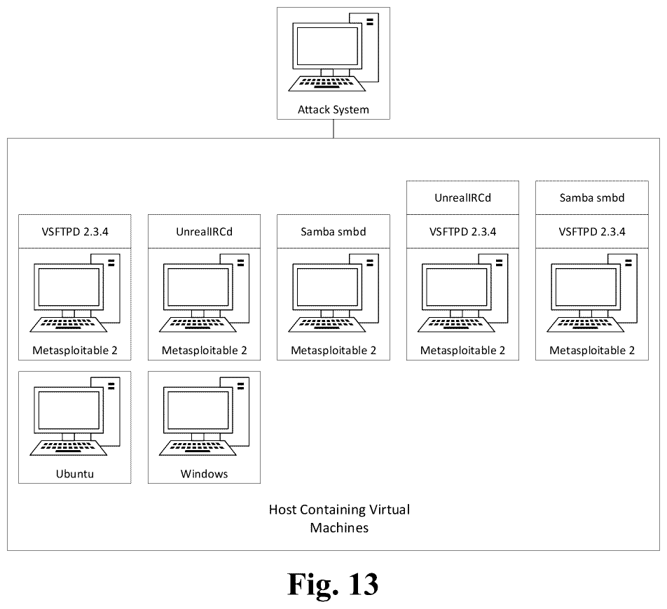

The second network also contained five vulnerable virtual machines, but also contained an Ubuntu image and a Windows image. In the first configuration of this network, the first Metasploitable2 image contained only the vsftpd vulnerability, the second Metasploitable2 image contained only the Unreal vulnerability, the third Metasploitable2 image contained only the Samba vulnerability, the fourth Metasploitable2 image contained the vsftpd and Samba vulnerabilities, and the fifth Metasploitable2 image contained the vsftpd and Unreal vulnerabilities. In the second configuration of this network, the first three Metasploitable2 images were the same as the first configuration, the fourth Metasploitable2 image contained all three vulnerabilities, and the fifth Metasploitable2 image contained the Samba and Unreal vulnerabilities. In the third configuration of this network, the first three Metasploitable2 images were the same as the first and second configurations, the fourth Metasploitable2 image contained the vsftpd and Unreal vulnerabilities, and the fifth Metasploitable2 image contained the Samba and Unreal vulnerabilities. The first configuration of Network 2 is depicted in FIG. 13. Table 3 lists the vulnerabilities for each configuration of network 2.

TABLE 3
Network Two Vulnerabilities.

| | | M1 | M2 | M3 | M4 | M5 |
|---|---|---|---|---|---|---|
| Configuration 1 | Vulnerabilities | V | U | S | VS | VU |
| Configuration 2 | Vulnerabilities | S | V | U | VUS | US |
| Configuration 3 | Vulnerabilities | U | S | V | VU | US |

V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

Network 2 was created to simulate a highly vulnerable environment with a few other secure virtual machines. The goal of this environment is to test the efficacy of the proposed system in a vulnerable environment with a few distractions. The different configurations of this network also contained three virtual machines with a single vulnerability of each type and a couple virtual machines with several vulnerabilities to test the efficacy of the system on adversaries with only a single vulnerability and on adversaries with multiple vulnerabilities. These configurations together also contained every combination of vulnerabilities on a single host to test the efficacy of the host on all possible combinations.

### Third Network

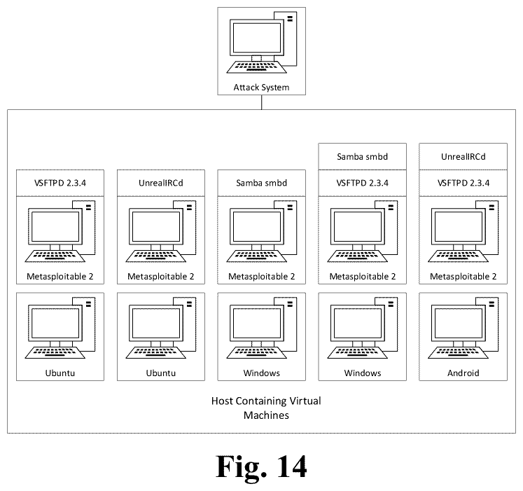

The third network also contained all of the virtual machines from the second network as well as a second Ubuntu image, a second Windows image, and an Android image. The first configuration of this network had the same vulnerabilities as the first configuration of the second network, so the first Metasploitable2 image contained only the vsftpd vulnerability, the second Metasploitable2 image contained only the Unreal vulnerability, the third Metasploitable2 image contained only the Samba vulnerability, the fourth Metasploitable2 image contained the vsftpd and Samba vulnerabilities, and the fifth Metasploitable2 image contained the vsftpd and Unreal vulnerabilities. In the second configuration of this network, the first four Metasploitable2 images were the same as the first configuration and the fifth Metasploitable2 image contained the Samba and Unreal vulnerabilities. In the third configuration of this network, the first three Metasploitable2 images were the same as the first and second configurations, the fourth Metasploitable2 image contained all three vulnerabilities, and the fifth Metasploitable2 image contained the Samba and Unreal vulnerabilities. The first configuration of Network 3 is depicted in FIG. 14. Table 4 lists the vulnerabilities for each configuration of network 3.

TABLE 4
Network Three vulnerabilities

| | | M1 | M2 | M3 | M4 | M5 |
|---|---|---|---|---|---|---|
| Configuration 1 | Vulnerabilities | V | U | S | VS | VU |
| Configuration 2 | Vulnerabilities | S | V | U | VS | US |
| Configuration 3 | Vulnerabilities | U | S | V | VUS | US |

V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

Network 3 was created with the intention to simulate a highly vulnerable network with a additional non-target virtual machines as compared to Network 2. The vulnerability configurations of this network are very similar to those of Network 2, with slight differences to test different combinations of vulnerable hosts. The main difference between this network and Network 2 is in the added non-target virtual machines. Like Network 1 and Network 2, the three configurations of Network 3 contained three virtual machines with a single vulnerability of each type and several virtual machines with several vulnerabilities to test the efficacy of the system on target systems with only a single vulnerability and on adversaries with multiple vulnerabilities. These configurations also, together, contained every possible combination of vulnerabilities to test the effectiveness of the system on all possibilities of vulnerabilities on a single virtual machine.

### Fourth Network

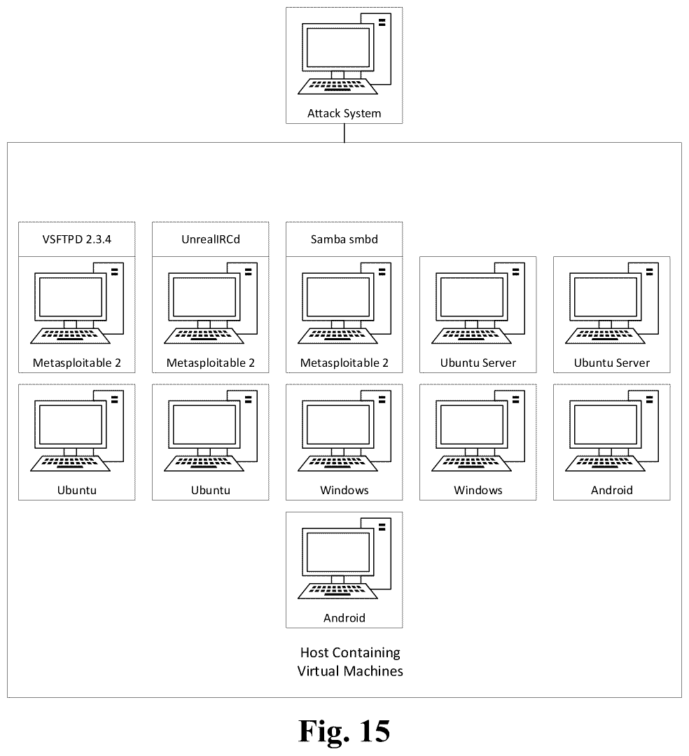

The fourth network is similar to the third network with two less Metasploitable2 virtual machines, the addition of two Ubuntu Server images, and the addition of one more Android image. In the first configuration of this network, the first Metasploitable2 image contained only the vsftpd vulnerability, the second Metasploitable2 image contained only the Unreal vulnerability, and the third Metasploitable2 image contained only the Samba vulnerability. In the second configuration of this network, the first Metasploitable2 image contained only the Samba vulnerability, the second Metasploitable2 image contained the vsftpd and Unreal vulnerabilities, and the third Metasploitable2 image contained all three vulnerabilities. In the third configuration of this network, the first Metasploitable2 image contained the vsftpd and Unreal vulnerabilities, the second Metasploitable2 image contained the Unreal and Samba vulnerabilities, and the third Metasploitable2 image contained the vsftpd and Samba vulnerabilities. The first configuration of Network 4 is depicted in FIG. 15. Table 5 lists the vulnerabilities for each configuration of network 4.

TABLE 5
Network Four vulnerabilities.

| | | M1 | M2 | M3 |
|---|---|---|---|---|
| Configuration 1 | Vulnerabilities | V | U | S |
| Configuration 2 | Vulnerabilities | S | VU | VUS |
| Configuration 3 | Vulnerabilities | VU | US | VS |

V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

Network 4 was designed to have notable differences from the other networks. This network contained only three vulnerable virtual machines instead of five. This network also contained more secure machines. The purpose of this network is to test the effectiveness of the proposed system in a simulated environment with fewer vulnerable targets and more secure targets. This network aims to make it more difficult for the system to find and exploit vulnerabilities. The configurations, again, contain every combination of vulnerabilities that are exploitable by the proposed system for a single Metasploitable2 image. This, again, allows for the system to be tested on every combination of vulnerabilities on a single host, with different combinations of vulnerable hosts.

### Fifth Network

The fifth network is similar to the fourth network with the addition of two more Metasploitable2 images and another Android image. In the first configuration of this network, the first Metasploitable2 image contained all three vulnerabilities, the second Metasploitable2 image contained the Unreal and Samba vulnerabilities, the third Metasploitable2 image contained the vsftpd and Samba vulnerabilities, the fourth Metasploitable2 image contained the Unreal and Samba vulnerabilities, and the fifth Metasploitable2 image contained all three vulnerabilities.

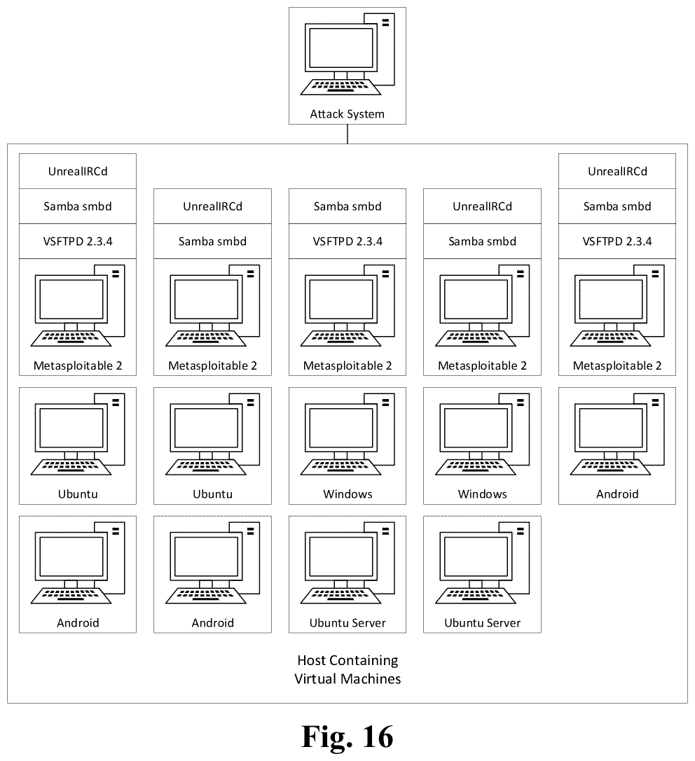

In the second configuration of this network, the first two Metasploitable2 images contained all three vulnerabilities, the third Metasploitable2 image contained the vsftpd and Samba vulnerabilities, the fourth Metasploitable2 image contained the Unreal and Samba vulnerabilities, and the fifth Metasploitable2 image contained the vsftpd and Samba vulnerabilities. In the third configuration of this network, the first Metasploitable2 image contained the vsftpd and Unreal vulnerabilities, the second Metasploitable2 image contained all three vulnerabilities, the third Metasploitable2 image contained the vsftpd and Unreal vulnerabilities, and the fourth and fifth Metasploitable2 images contained all three vulnerabilities. The first configuration of Network 5 is depicted in FIG. 16. Table 6 lists the vulnerabilities for each configuration of network 5.

TABLE 6
Network Five vulnerabilities

| | | M1 | M2 | M3 | M4 | M5 |
|---|---|---|---|---|---|---|
| Configuration 1 | Vulnerabilities | VUS | US | VS | US | VUS |
| Configuration 2 | Vulnerabilities | VUS | VUS | VS | VS | VS |
| Configuration 3 | Vulnerabilities | VU | VUS | VU | VUS | VUS |

V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

Network 5 simulates a larger computer network than the other four networks. This network includes five vulnerable Metasploitable2 virtual machines along with 14 non-target virtual machines. The purpose of this network is to test the efficacy of the proposed system on a larger network with more secure computers that distract the system from its goal. Again, this network contained many combinations of vulnerabilities on a single virtual machine, but this time did not contain the single vulnerabilities. This is because the single vulnerabilities have already been well tested by the other networks. This allows for more combinations of highly vulnerable virtual machines with multiple vulnerabilities each. The prioritization of the proposed system and the ability to stop exploitation when the system has already gained access to a machine were tested by this network.

### Experimental Design

The experiment was separated into two parts to isolate the command module test results from the scanning module test results. The first component of the experiment aimed to test the scanning module. This section tested the timing, type, and amount of data collected from different NMap scanning methods to determine which scanning method would work best with the command module. The second component tested the command module of the system. The attack and verify modules were also evaluated in this component because they are invoked by the command module.

The system was tested by running it against five different adversary computer networks, each with three different security configurations. The different networks and security configurations were described in detail in Section 4.1. To test the blackboard network, the different network and security configurations were changed between each test. Due to the number of tests, a batch file automatically set up the virtual machines for each network and configuration and ran each test. For each configuration, the virtual machines were set up to a state saved before they were attacked.

There were two types of data collected in the command system component of the experiment. The first type of data collected was the type of exploit, if any, that was run on each host. If an exploit was successful against a host, no more exploits were run against that host since the system was already comprised. The three exploits used were the Samba exploit (which shut down the computer) the UnrealIRCd exploit (which changed a webpage), and the vsftpd exploit (which also changed a webpage). The other type of data collected was he duration it took the system to run. The timing data measured only the control, attack, and verify modules. The timing data did not include the time to setup the virtual machine networks and configurations or the scanning module.

### Data and Analysis

The two different parts of the experiment collected different types of data. The scanning module was used first to collect data on what the most effective scanning options would be for the control module. This aided in identifying potential vulnerabilities that exist within the target systems. Using this information, the second part of the experiment used the command module to exploit vulnerable targets.

When exploiting vulnerable targets, the system collected two different data types. Below are discussed the scanning module data and the command system operations data related to exploit selection and operating time, respectively.

### Scanning Module

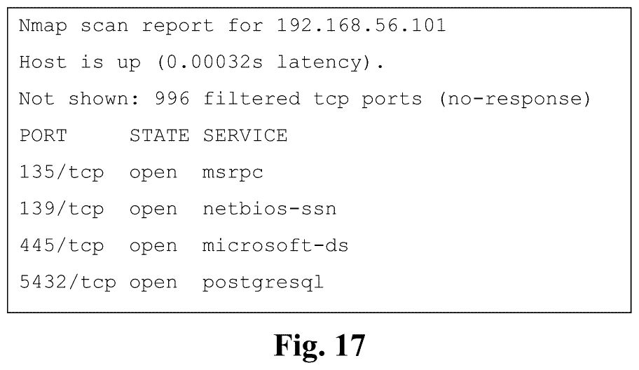

The scanning module was evaluated to assess its speed of operations and efficacy. Scan data was outputted from it (as shown in FIG. 17) and fed into the ingestion system for the Blackboard Architecture network. The principal validations of the efficacy of the NMap scanner came from the successful ingestion of the outputted data and its demonstrated efficacy at identifying target computers and ports to attack. Thus, the results of the subsequently discussed system operations also serve to validate the NMap parser's effective use and efficacy. To inform decision making for the operational use of NMap, testing was conducted to ascertain how much time it would take to conduct a scan under different conditions. Three conditions were assessed, running a scan of a /24 block operating as a normal user, running this same scan as a user with administrative rights and running the scan using the NMap scripting engine. The commands that were run for each, respectively, were:
Banner grab as standard user: -sS -sV --version-intensity 5 192.168.56.0/24, output logged to banner_grab.txt.
Banner grab as administrator: -sS -sV --version-intensity 5 192.168.56.0/24, output logged to admin_banner_grab.txt.
Banner grab using the NMap scripting engine: -sV --script=banner, output logged to admin_script_engine.txt.

TABLE 7
Scanning results: data obtained and execution Time

| Banner Grab - | Banner Grab - | Banner Grab with nmap |
|---|---|---|
| Standard User | Admin | scripting engine |
| 46.14 seconds | 46.10 seconds | 99.54 seconds |
| 167 lines in log file | 167 lines in log file | 275 lines in log file |

Notably, the standard user versus administrative rights nmap scans took a functionally equivalent amount of time (only a 0.04 second difference between them). The nmap scripting engine banner grab was able to probe more deeply in RPC services running on each host than the banner grabs using the -sS -sV options and, thus, took a longer amount of time. Because of this, it took significantly longer (approximately double) to run than the other scans

This additional time showed itself to be helpful. For example, a host (at 192.168.56.106) was discovered to be running an rpcbind service on port 111. The scripting engine banner grab discovered 10 ports running RPC services which include TCP and UDP ports. The -sS -sV options only discovered the existence the rpcbind service on port 111 but could not see any of the TCP or UDP ports allocated by the RPC service.

### Command Module Chosen Exploits.

For the first part of the command module experiment, the data shows which vulnerability was exploited for each configuration of each network. The first row of each configuration in Tables 8 to 12 lists the vulnerabilities on the virtual machine. The second row of each configuration lists the vulnerability that was exploited by the command system. Because the virtual machines running operating systems other than Metaspoitable2 have no vulnerabilities that are exploitable by the system, their data was not included in these tables. Each configuration was tested 10 times, and every test produced the same exploit selections.

TABLE 8
Comparison between the chosen exploit of different configurations
performed against each host in Network One.

| | | M1 | M2 | M3 | M4 | M5 |
|---|---|---|---|---|---|---|
| Configuration 1 | Vulnerabilities | V | U | S | VUS | VU |
| | Completed Exploit | V | U | S | V | V |
| Configuration 2 | Vulnerabilities | S | V | U | VS | US |
| | Completed Exploit | S | V | U | V | U |
| Configuration 3 | Vulnerabilities | U | S | V | VU | US |
| | Completed Exploit | U | S | V | V | U |

M1, M2, M3, M4, and M5 stand for Metasploitable2 images. V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

TABLE 9
Comparison between the chosen exploit of different configurations
performed against each host in Network Two.

| | | M1 | M2 | M3 | M4 | M5 |
|---|---|---|---|---|---|---|
| Configuration 1 | Vulnerabilities | V | U | S | VS | VU |
| | Completed Exploit | V | U | S | V | V |
| Configuration 2 | Vulnerabilities | S | V | U | VUS | US |
| | Completed Exploit | S | V | U | V | U |
| Configuration 3 | Vulnerabilities | U | S | V | VU | US |
| | Completed Exploit | U | S | V | V | U |

M1, M2, M3, M4, and M5 stand for Metasploitable2 images. V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

TABLE 10
Comparison between the chosen exploit of different configurations
performed against each host in Network THREE.

| | | M1 | M2 | M3 | M4 | M |
|---|---|---|---|---|---|---|
| Configuration 1 | Vulnerabilities | V | U | S | VS | V |
| | Completed Exploit | V | U | S | V | U |
| Configuration 2 | Vulnerabilities | S | V | U | VUV | US |
| | Completed Exploit | S | V | U | | U |
| Configuration 3 | Vulnerabilities | U | S | V | VUS | US |
| | Completed Exploit | U | S | V | V | U |

M1, M2, M3, M4, and M5 stand for Metasploitable2 images. V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

TABLE 11
Comparison between the chosen exploit of different configurations
performed against each host in Network Four.

| | | M1 | M2 | M3 |
|---|---|---|---|---|
| Configuration 1 | Vulnerabilities | V | U | S |
| | Completed Exploit | V | U | S |
| Configuration 2 | Vulnerabilities | S | VU | VU |
| | Completed Exploit | S | V | S |
| Configuration 3 | Vulnerabilities | VU | US | VS |
| | Completed Exploit | V | U | V |

M1, M2, M3, M4, and M5 stand for Metasploitable2 images. V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

TABLE 12
Comparison between the chosen exploit of different configurations
performed against each host in Network Five.

| | | M1 | M2 | M3 | M4 | M5 |
|---|---|---|---|---|---|---|
| Configuration 1 | Vulnerabilities | VUS | US | VS | US | VUS |
| | Completed | V | U | V | U | V |
| Configuration 2 | Vulnerabilities | VUS | VUS | VS | VS | VS |
| | Completed | V | V | V | V | V |
| Configuration 3 | Vulnerabilities | VU | VUS | VU | V | VUS |
| | Completed | V | V | V | U | V |

M1, M2, M3, M4, and M5 stand for Metasploitable2 images. V, U, and S represent vulnerabilities on each Metasploitable2 image with a combination meaning that the image has multiple vulnerabilities. V represents the vsftpd vulnerability, U represents the UnrealIRCd vulnerability, and S stands for the Samba Vulnerability.

As shown in Tables 8 to 12, each virtual machine running Metasploitable2 had exactly one exploit run against it. The number of vulnerabilities the system exploited is the same as the number of vulnerable virtual machines. The system, in accordance with its design, exhibited a prioritization pattern for exploit selection. If the vsftpd vulnerability was present, it was selected. If the vsftpd vulnerability was not present and the Unreal vulnerability was, the Unreal exploit was run. Otherwise, the Samba exploit was run. Although Tables 8, 9 and 10 do not share the exact same vulnerabilities per host, the exploits are common between them. Each exploit was successful every time.

### Command Module Execution Time

In the second part of the command module experiment, the runtime of the command module was recorded for each configuration for each network. The timing for the experiment included the control module, attack module, and verify module, and not the initial scanning module timing. Each configuration was tested 10 times. Tables 13 to 17 show the average, median, standard deviation, minimum, and maximum runtime from the ten tests run for each configuration. Each table contains results for each network and its three configurations. The results in Tables 13 to 17 are shown in milliseconds.

TABLE 13
Comparison between runtimes of different
configurations in Network One (ms).

| | | | Standard | | |
|---|---|---|---|---|---|
| | Average | Median | Deviation | Min | Max |
| Configuration 1 | 425954 | 426129 | 3086 | 421404 | 432293 |
| Configuration 2 | 491541 | 493631 | 15079 | 461220 | 508324 |
| Configuration 3 | 399241 | 398750 | 2281 | 396397 | 404134 |

TABLE 14
Comparison between runtimes of different
configurations in Network Two (ms).

| | | | Standard | | |
|---|---|---|---|---|---|
| | Average | Median | Deviation | Min | Max |
| Configuration 1 | 416740 | 417546 | 4026 | 409993 | 421990 |
| Configuration 2 | 518027 | 496230 | 81064 | 468585 | 746452 |
| Configuration 3 | 446241 | 447347 | 6248 | 436146 | 454624 |

TABLE 15
Comparison between runtimes of different
configurations in Network Three (ms).

| | | | Standard | | |
|---|---|---|---|---|---|
| | Average | Median | Deviation | Min | Max |
| Configuration 1 | 418990 | 420161 | 4705 | 409230 | 425183 |
| Configuration 2 | 456273 | 492039 | 56707 | 384540 | 509723 |
| Configuration 3 | 406320 | 407948 | 8589 | 395945 | 423361 |

TABLE 16
Comparison between runtimes of different
configurations in Network Four (ms).

| | | | Standard | | |
|---|---|---|---|---|---|
| | Average | Median | Deviation | Min | Max |
| Configuration 1 | 254427 | 253635 | 3497 | 250111 | 260427 |
| Configuration 2 | 227337 | 227266 | 2514 | 223403 | 231523 |
| Configuration 3 | 225395 | 225467 | 2391 | 221878 | 228688 |

TABLE 17
Comparison between runtimes of different
configurations in Network Five (ms).

| | | | Standard | | |
|---|---|---|---|---|---|
| | Average | Median | Deviation | Min | Max |
| Configuration 1 | 383158 | 381055 | 6859 | 376086 | 394553 |
| Configuration 2 | 361225 | 361425 | 1472 | 358601 | 363601 |
| Configuration 3 | 365347 | 367185 | 4200 | 359294 | 370778 |

The data presented in the tables has some noticeable properties. First, network 4 took less time to run than any of the other networks. Additionally, for most of the different configurations the standard deviation of the ten runs on each configuration was between around 0.4% and 2% of the overall runtime, showing how the Blackboard Architecture system was able to perform incredibly consistently against the same network and configuration over multiple iterations. However, in networks 1 to 3, the second configuration for each network had a standard deviation that was notably higher than other standard deviations throughout the experiment. Another notable trend is that average, median, minimum, and maximum have small variations between configurations in each network. The exceptions to this pattern are configuration 2 of network 1, configuration 2 of network 2, and configuration 2 of network 3. Another exception is that in configuration 1 of networks 4 and 5, there is a slight increase in all statistics compared to the other configurations of their respective networks.

### Analysis

Overall, the experiments that were performed demonstrated the efficacy of the proposed system. It worked under all scenarios and demonstrated consistency in its operations. More fundamentally, the system demonstrated the efficacy of the Blackboard Architecture for cybersecurity applications of this type and penetration testing, more specifically.

The command system chooses which vulnerabilities to exploit in a straightforward way. There were no explicit priorities given to certain vulnerabilities, so the system created its own prioritization. Reviewing Tables 8-12, the system prioritized vulnerabilities based on the order that the vulnerability facts were created. The system begins by making a fact for the vsftpd vulnerability, then a fact for the Unreal vulnerability, then lastly a fact for the Samba vulnerability. This matches the order of prioritization of the system. This also explains why the chosen exploits for networks 1, 2, and 3 were the same. For the first three Metasploitable2 images, the configurations for each network were the same; they also contained only one vulnerability. Since there was only one logical choice for an exploit, they all chose the same. For the last two Metasploitable2 images, each configuration of each network contained the vsftpd vulnerability. Since the system appears to give highest priority to the vsftpd vulnerability, the rest of the values of these tables matched. Notably, absolute priority, a round-robin approach or other selection mechanisms could be implemented by changing the Blackboard Architecture networks that are created.

There were no failed exploit attempts. One probable reason for this is the lack of defensive variations between networks and configurations. This means that nothing prevents the attack script from succeeding when running against the correct vulnerability.

Overall, the number of hosts within a network had a negligible impact on the runtime of the system in comparison to the number of hosts that contain vulnerabilities within the network. This can be seen in all three configurations of network 4 as the runtime of network 4 is much lower than any of the other four networks. This is due to their only being three vulnerable hosts within the network unlike the other networks which each contained five vulnerable hosts. The lack of correlation between network runtime and additional hosts without vulnerabilities can be clearly seen as all four networks with five vulnerable hosts take similar amounts of time to run, as well as network five had the lowest runtime when the network had the most additional hosts.

The increase in all statistics in configuration 2 for networks 1, 2, and 3 when compared to the configurations in their respective networks is an interesting pattern. A potential explanation for this comes from comparing Tables 8 to 12 with Tables 13 to 17. Configuration 2 of networks 1, 2, and 3 seems to only differ from the other networks by beginning with the Samba exploit. The second configuration of network 4 also begins with Samba, however. One explanation for the statistics for the first configuration of networks 4 and 5 being greater than the statistics of the configurations of the respective networks is that there is only one type of vulnerability exploited. It is notable that the system, overall, showed robustness to this phenomenon. It was still successful, despite this unexpected occurrence.

Summarizing, described herein is an automated cybersecurity assessment system that uses a Blackboard Architecture-based command module for penetration testing. It uses artificial intelligence as both a tool for vulnerability detection and identification, as well as for an automated exploitation tool. The system presented herein performs automated cybersecurity assessments that can identify and exploit system vulnerabilities. This was done using a Blackboard Architecture system as a command module for an autonomous cybersecurity assessment tool. The separation of modules into scanning, attack, control, and verify has been discussed with the use of a blackboard system comprised of rules, facts, actions, and verifiers.

The system uses multiple modules for its tasks: scanning, attack, control, and verification. The command mechanisms are implemented using a blackboard system comprised of rules, facts, actions, and verifiers. We demonstrate that the system can operate under a variety of experimental conditions and with consistency, both in terms of time taken and outcome, from run to run. This work, thus, has shown that a Blackboard Architecture-based system can be effective in exploiting a list of known vulnerabilities against networks of varied sizes and types of operating systems. It has also demonstrated that the system can discern which machines have vulnerabilities that it knows how to attack, target attacks based on which vulnerabilities are present and identify which systems do not have vulnerabilities that the penetration testing system can exploit.

The scan, attack, verify and command components were combined to create a cybersecurity assessment tool with the capability to adapt to different operating systems, vulnerabilities, and attack vectors. The modularity of each component facilitated customization to meet varying goals. This autonomous cybersecurity assessment tool reduces the involvement required from a cybersecurity specialist when performing a penetration test. Also, the system can run for longer periods of time than a human could, which allows for a quicker assessment of large repetitive networks. An autonomous system can also run during times when humans are not using the network and can even replace cybersecurity professionals when there are not enough available. The system proved to be able to effectively assess whether a vulnerability was exploitable or not and did not attempt to attack a system with an exploit that would be ineffective.

Because of these capabilities, the potential for human error in reporting common vulnerabilities is reduced. Documentation of the penetration test can also be performed automatically, and attacks can be conducted more thoroughly and potentially using a larger repertoire of exploits than a human pen tester would be capable of.

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

### REFERENCES

Straub, J. Blackboard-based electronic warfare system. In Proceedings of the ACM Conference on Computer and Communications Security; 2015; Vol. 2015-Octob.
Hasan, S.; Ghafouri, A.; Dubey, A.; Karsai, G.; Koutsoukos, X. Vulnerability analysis of power systems based on cyber-attack and defense models. 2018 IEEE Power Energy Soc. Innov. Smart Grid Technol. Conf. ISGT 2018 2018, 1-5, doi: 10.1109/ISGT.2018.8403337.
Eling, M.; Wirfs, J. What are the actual costs of cyber risk events? Eur. J. Oper. Res. 2019, 272, 1109-1119, doi: 10.1016/J.EJOR.2018.07.021.
Mateski, M.; Trevino, C. M.; Veitch, C. K.; Michalski, J.; Harris, J. M.; Maruoka, S.; Frye, J. Cyber Threat Metrics; Albuquerque, New Mexico, 2012.
Mavroeidis, V.; Hohimer, R.; Casey, T.; Jesang, A. Threat Actor Type Inference and Characterization within Cyber Threat Intelligence. Int. Conf. Cyber Conflict, CYCON 2021, 2021-May, 327-352, doi: 10.23919/CYCON51939.2021.9468305.
King, Z. M.; Henshel, D. S.; Flora, L.; Cains, M. G.; Hoffman, B.; Sample, C. Characterizing and measuring maliciousness for cybersecurity risk assessment. Front. Psychol. 2018, 9, 1-19, doi: 10.3389/fpsyg.2018.00039.
Zhao, J.; Shao, M.; Wang, H.; Yu, X.; Li, B.; Liu, X. Cyber threat prediction using dynamic heterogeneous graph learning. Knowledge-Based Syst. 2022, 240, 108086, doi:10.1016/J.KNOSYS.2021.108086.
Gao, Y.; Li, X.; Peng, H.; Fang, B.; Yu, P. S. HinCTI: A Cyber Threat Intelligence Modeling and Identification System Based on Heterogeneous Information Network. IEEE Trans. Knowl. Data Eng. 2020, 34, 708-722, doi: 10.1109/TKDE.2020.2987019.
Sipper, J. A. Cyber Threat Intelligence and the Cyber Meta-Reality and Cyber Microbiome. Int. Conf. Cyber Secur. Prot. Digit. Serv. Cyber Secur. 2020 2020, doi: 10.1109/CYBERSECURITY49315.2020.9138858.
Parmar, M.; Domingo, A. On the Use of Cyber Threat Intelligence (CTI) in Support of Developing the Commander's Under-standing of the Adversary. Proc.-IEEE Mil. Commun. Conf. MILCOM 2019, 2019-November, doi: 10.1109/MIL-COM47813.2019.9020852.
Ullah, S.; Shetty, S.; Nayak, A.; Hassanzadeh, A.; Hasan, K. Cyber Threat Analysis Based on Characterizing Adversarial Behavior for Energy Delivery System. Lect. Notes Inst. Comput. Sci. Soc. Telecommun. Eng. LNICST 2019, 305 LNICST, 146-160, doi: 10.1007/978-3-030-37231-6_8.
Kesswani, N.; Kumar, S. Maintaining Cyber Security: Implications, Cost and Returns. In Proceedings of the SIGMIS-CPR′15;ACM: Newport Beach, C A, 2015; pp. 161-164.
Gordon, L. A.; Loeb, M. P. The Economics of Information Security Investment. ACM Trans. Inf. Syst. Secur. 2002, 5, 438-457.
Dreyer, P.; Jones, T.; Klima, K.; Oberholtzer, J.; Strong, A.; Welburn, J. W.; Winkelman, Z. Estimating the Global Cost of Cyber Risk: Methodology and Examples; Santa Monica, C A, 2018.
Strom, B. E.; Battaglia, J. A.; Kemmerer, M. S.; Kupersanin, W.; Miller, D. P.; Wampler, C.; Whitley, S. M.; Wolf, R. D. Finding CyberThreats with ATT&CK™-Based Analytics; 2017.
Yadav, T.; Rao, A. M. Technical Aspects of Cyber Kill Chain. In; Springer, Cham, 2015; pp. 438-452.
Khan, R.; Mclaughlin, K.; Laverty, D.; Sezer, S. STRIDE-based threat modeling for cyber-physical systems. In Proceedings of the 2017 IEEE PES Innovative Smart Grid Technologies Conference Europe, ISGT-Europe 2017-Proceedings; Institute of Electrical and Electronics Engineers Inc., 2017; Vol. 2018-January, pp. 1-6.
Bhuiyan, T. H.; Nandi, A. K.; Medal, H.; Halappanavar, M. Minimizing expected maximum risk from cyber-Attacks with probabilistic attack success. 2016 IEEE Symp. Technol. Homel. Secur. HST 2016 2016, doi: 10.1109/THS.2016.7568892.
Lallie, H. S.; Debattista, K.; Bal, J. A review of attack graph and attack tree visual syntax in cyber security. Comput. Sci. Rev. 2020, 35, 100219, doi:10.1016/J.COSREV.2019.100219.
Nandi, A. K.; Medal, H. R.; Vadlamani, S. Interdicting attack graphs to protect organizations from cyberattacks: A bi-level defender-attacker model. Comput. Oper. Res. 2016, 75, 118-131, doi: 10.1016/J.COR.2016.05.005.
Straub, J. Modeling Attack, Defense and Threat Trees and the Cyber Kill Chain, ATT&CK and STRIDE Frameworks as Blackboard Architecture Networks. In Proceedings of the 2020 IEEE International Conference on Smart Cloud; Institute of Electrical and Electronics Engineers Inc.: Washington, DC, USA, 2020; pp. 148-153.
Gu, G.; Zhang, J.; Lee, W. BotSniffer: Detecting Botnet Command and Control Channels in Network Traffic. In Proceedings of the 15th Annual Network and Distributed System Security Symposium; 2008.
Gardiner, J.; Cova, M.; Nagaraja, S. Command & Control: Understanding, Denying and Detecting-A review of malware C2 techniques, detection and defences. arXiv Prepr. arXiv1408.1136 2014.
Fogla, P.; Sharif, M.; Perdisci, R.; Kolesnikov, O.; Lee, W. Polymorphic Blending Attacks. In Proceedings of the Proceedings of Security '06: 15th USENIX Security Symposium; USENIX Association, 2006; pp. 241-256.
Dittrich, D.; Dietrich, S. Command and Control Structures in Malware. Login 2007, 32, 8-17.
Cisco Systems, I. Cisco IOS NetFlow Available online: cisco.com/c/en/us/products/ios-nx-os-software/ios-netflow/index.html (accessed on Jan. 26, 2022).
CrowdStrike What is Lateral Movement Available online: crowdstrike.com/cybersecurity-101/lateral-movement/(accessed on Jan. 28, 2022).
Fawaz, A.; Bohara, A.; Cheh, C.; Sanders, W. H. Lateral Movement Detection Using Distributed Data Fusion. Proc. IEEE Symp. Reliab. Distrib. Syst. 2016, 21-30, doi: 10.1109/SRDS.2016.014.
Hacks, S.; Butun, I.; Lagerström, R.; Buhaiu, A.; Georgiadou, A.; Michalitsi-Psarrou, A. Integrating Security Behavior into Attack Simulations. In Proceedings of the ARES 2021 Conference; ACM: Vienna, Austria, 2021; p. 13.
Wotawa, F. On the automation of security testing. Proc.-2016 Int. Conf. Softw. Secur. Assur. ICSSA 2016 2017, 11-16, doi: 10.1109/ICSSA.2016.9.
Thompson, H. H. Why security testing is hard. IEEE Secur. Priv. 2003, 1, 83-86, doi:10.1109/MSECP.2003.1219078.
Guo, F.; Yu, Y.; Chiueh, T. C. Automated and safe vulnerability assessment. Proc.-Annu. Comput. Secur. Appl. Conf. ACSAC 2005, 2005, 150-159, doi: 10.1109/CSAC.2005.11.
Mohammad, S. M.; Surya, L. Security Automation in Information Technology. Int. J. Creat. Res. Thoughts 2018, 6.
Metheny, M. Continuous monitoring through security automation. Fed. Cloud Comput. 2017, 453-472, doi: 10.1016/B978-O-12-809710-6.00013-5.
Shah, M. P. Comparative Analysis of the Automated Penetration Testing Tools, National College of Ireland: Dublin, 2020.
Bhardwaj, A.; Shah, S. B. H.; Shankar, A.; Alazab, M.; Kumar, M.; Gadekallu, T. R. Penetration testing framework for smart contract Blockchain. Peer-to-Peer Netw. Appl. 2021, 14, 2635-2650, doi: 10.1007/S12083-020-00991-6/TABLES/7.
Casola, V.; De Benedictis, A.; Rak, M.; Villano, U. A methodology for automated penetration testing of cloud applications. Int. J. Grid Util. Comput. 2020, 11, 267-277, doi: 10.1504/IJGUC.2020.105541.
Casola, V.; De Benedictis, A.; Rak, M.; Villano, U. Towards automated penetration testing for cloud applications. Proc.-2018 IEEE 27th Int. Conf. Enabling Technol. Infrastruct. Collab. Enterp. WETICE 2018 2018, 30-35, doi: 10.1109/WETICE.2018.00012.
Yadav, G.; Allakany, A.; Kumar, V.; Paul, K.; Okamura, K. Penetration Testing Framework for IoT. Proc.-2019 8th Int. Congr. Adv. Appl. Informatics, IIAI-AAI 2019 2019, 477-482, doi: 10.1109/IIAI-AAI.2019.00104.
Kadam, S. P.; Mahajan, B.; Patanwala, M.; Sanas, P.; Vidyarthi, S. Automated Wi-Fi penetration testing. Int. Conf. Electr. Electron. Optim. Tech. ICEEOT 2016 2016, 1092-1096, doi: 10.1109/ICEEOT.2016.7754855.
Falkenberg, A.; Mainka, C.; Somorovsky, J.; Schwenk, J. A new approach towards DoS penetration testing on web services. Proc.-IEEE 20th Int. Conf. Web Serv. ICWS 2013 2013, 491-498, doi: 10.1109/ICWS.2013.72.
Antunes, N.; Vieira, M. Penetration testing for web services. Computer (Long. Beach. Calif). 2014, 47, 30-36, doi:10.1109/MC.2013.409.
Mainka, C.; Somorovsky, J.; Schwenk, J. Penetration testing tool for web services security. Proc.-2012 IEEE 8th World Congr. Serv. Serv. 2012 2012, 163-170, doi: 10.1109/SERVICES.2012.7.
Singh, N.; Meherhomji, V.; Chandavarkar, B. R. Automated versus Manual Approach of Web Application Penetration Testing. 2020 11th Int. Conf. Comput. Commun. Netw. Technol. ICCCNT 2020 2020, doi:10.1109/ICCCNT49239.2020.9225385.
Shah, S.; Mehtre, B. M. An automated approach to vulnerability assessment and penetration testing using net-nirikshak 1.0. 780 Proc. 2014 IEEE Int. Conf. Adv. Commun. Control Comput. Technol. ICACCCT 2014 2015, 707-712, doi:10.1109/ICACCCT.2014.7019182.
Almubairik, N. A.; Wills, G. Automated penetration testing based on a threat model. 2016 11th Int. Conf. Internet Technol. Secur. Trans. ICITST 2016 2017, 413-414, doi: 10.1109/ICITST.2016.7856742.
Stepanova, T.; Pechenkin, A.; Lavrova, D. Ontology-based big data approach to automated penetration testing of large-scale heterogeneous systems. ACM Int. Conf. Proceeding Ser. 2015, 08-10 Sep. 2015, doi: 10.1145/2799979.2799995.
Halfond, W. G. J.; Choudhary, S. R.; Orso, A. Improving penetration testing through static and dynamic analysis. Softw. Testing, Verif. Reliab. 2011, 21, 195-214, doi:10.1002/STVR.450.
Luan, J.; Wang, J.; Xue, M. Automated Vulnerability Modeling and Verification for Penetration Testing Using Petri Nets. Lect. Notes Comput. Sci. (including Subser. Lect. Notes Artif. Intell. Lect. Notes Bioinformatics) 2016, 10040, 71-82, doi: 10.1007/978-3-319-48674-1 7.
Alhassan, J. K.; Misra, S.; Umar, A.; Maskeliünas, R.; Damaševičius, R.; Adewumi, A. A Fuzzy Classifier-Based Penetration Testing for Web Applications. Adv. Intell. Syst. Comput. 2018, 721, 95-104, doi: 10.1007/978-3-319-73450-7 10.
Rak, M.; Salzillo, G.; Granata, D. ESSecA: An automated expert system for threat modelling and penetration testing for IoT ecosystems. Comput. Electr. Eng. 2022, 99, 107721, doi: 10.1016/J.COMPELECENG.2022.107721.
Greenwald, L.; Shanley, R. Automated planning for remote penetration testing. Proc.-IEEE Mil. Commun. Conf. MILCOM 2009, doi: 10.1109/MILCOM.2009.5379852.
Zhou, T. yang; Zang, Y. chao; Zhu, J. hu; Wang, Q. xian NIG-AP: a new method for automated penetration testing. Front. Inf. Technol. Electron. Eng. 2019 209 2019, 20, 1277-1288, doi: 10.1631/FITEE.1800532.
Chowdhary, A.; Huang, D.; Mahendran, J. S.; Romo, D.; Deng, Y.; Sabur, A. Autonomous security analysis and penetration testing. Proc.-2020 16th Int. Conf. Mobility, Sens. Networking, M S N 2020 2020, 508-515, doi: 10.1109/MSN50589.2020.00086.
Chu, G.; Lisitsa, A. Poster: Agent-based (BDI) modeling for automation of penetration testing. 2018 16th Annu. Conf. Privacy, Secur. Trust. PST 2018 2018, doi: 10.1109/PST.2018.8514211.
Ghanem, M. C.; Chen, T. M. Reinforcement Learning for Intelligent Penetration Testing. Proc. 2nd World Conf. Smart Trends Syst. Secur. Sustain. WorldS4 2018 2019, 90-95, doi: 10.1109/WORLDS4.2018.8611595.
Schwartz, J.; Kurniawati, H. Autonomous Penetration Testing using Reinforcement Learning. 2019.
Gangupantulu, R.; Cody, T.; Park, P.; Rahman, A.; Eisenbeiser, L.; Radke, D.; Clark, R. Using Cyber Terrain in Reinforcement Learning for Penetration Testing. 2021.
Ghanem, M. C.; Chen, T. M. Reinforcement Learning for Efficient Network Penetration Testing. Inf. 2020, Vol. 11, Page 6 2019, 11, 6, doi: 10.3390/INFO11010006.
Chaudhary, S.; O'Brien, A.; Xu, S. Automated Post-Breach Penetration Testing through Reinforcement Learning. 2020 IEEE Conf. Commun. Netw. Secur. CNS 2020 2020, doi:10.1109/CNS48642.2020.9162301.
Hu, Z.; Beuran, R.; Tan, Y. Automated Penetration Testing Using Deep Reinforcement Learning. Proc.-5th IEEE Eur. Symp. Secur. Priv. Work. Euro S PW 2020 2020, 2-10, doi:10.1109/EUROSPW51379.2020.00010.
Tran, K.; Akella, A.; Standen, M.; Kim, J.; Bowman, D.; Richer, T.; Lin, C.-T. Deep hierarchical reinforcement agents for automated penetration testing. 2021.
Dai, Z.; Lv, L.; Liang, X.; Bo, Y. Network penetration testing scheme description language. Proc.-2011 Int. Conf. Comput. Inf. Sci. ICCIS 2011 2011, 804-808, doi: 10.1109/ICCIS.2011.181.
Stefinko, Y.; Piskozub, A.; Banakh, R. Manual and automated penetration testing. Benefits and drawbacks. Modern tendency. 819 Mod. Probl. Radio Eng. Telecommun. Comput. Sci. Proc. 13th Int. Conf. TCSET 2016 2016, 488-491, doi: 10.1109/TCSET.2016.7452095.
Hayes-Roth, B. A blackboard architecture for control. Artif. Intell. 1985, 26, 251-321.
Erman, L. D.; Hayes-Roth, F.; Lesser, V. R.; Reddy, D. R. The Hearsay-II speech-understanding system: Integrating knowledge to resolve uncertainty. ACM Comput. Surv. 1980, 12, 213-253.
Feigenbaum, E. A.; Buchanan, B. G.; Lederberg, J. On generality and problem solving: A case study using the DENDRAL program. 1970.
Zwass, V. Expert system Available online: www.britannica.com/technology/expert-system (accessed on Feb. 24, 2021).
Lindsay, R. K.; Buchanan, B. G.; Feigenbaum, E. A.; Lederberg, J. DENDRAL: A case study of the first expert system for scientific hypothesis formation. Artif. Intell. 1993, 61, 209-261, doi: 10.1016/0004-3702(93)90068-M.
Corkill, D. D. Blackboard Systems. AI Expert 1991, 6.
Dong, J.; Chen, S.; Jeng, J.-J. Event-based blackboard architecture for multi-agent systems. In Proceedings of the Information Technology: Coding and Computing, 2005. ITCC 2005. International Conference on; IEEE, 2005; Vol. 2, pp. 379-384.
Huang, M.-J.; Chiang, H.-K.; Wu, P.-F.; Hsieh, Y.-J. A multi-strategy machine learning student modeling for intelligent tutoring systems: based on Blackboard approach. Libr. Hi Tech 2013, 31, 6.
Brzykcy, G.; Martinek, J.; Meissner, A.; Skrzypczynski, P. Multi-agent blackboard architecture for a mobile robot. In Proceedings 835 of the Intelligent Robots and Systems, 2001. Proceedings. 2001 IEEE/RSJ International Conference on; IEEE, 2001; Vol. 4, pp. 2369-2374.
Yang, Y.; Tian, Y.; Mei, H. Cooperative Q learning based on blackboard architecture. In Proceedings of the International Conference on Computational Intelligence and Security Workshops, 2007; IEEE, 2007; pp. 224-227.
Johnson Jr, M. V; Hayes-Roth, B. Integrating Diverse Reasoning Methods in the BBP Blackboard Control Architecture1. In Proceedings of the Proceedings of the AAAI; 1987; pp. 30-35.
de Campos, A. M.; Monteiro de Macedo, M. J. A blackboard architecture for perception planning in autonomous vehicles. In 842 Proceedings of the Industrial Electronics, Control, Instrumentation, and Automation, 1992. Power Electronics and Motion Control, Proceedings of the 1992 International Conference on; IEEE, 1992; pp. 826-831.
Straub, J. A modern Blackboard Architecture implementation with external command execution capability. Softw. Impacts 2022, 11, 100183, doi:10.1016/J.SIMPA.2021.100183.
Juniper Research Business Losses to Cybercrime Data Breaches to Exceed $5 trillion Available online: www.juniperresearch.com/press/business-losses-cybercrime-data-breaches (accessed on Jan. 26, 2022).
Zeadally, S.; Adi, E.; Baig, Z.; Khan, I. A. Harnessing artificial intelligence capabilities to improve cybersecurity. IEEE Access 2020, 8, 23817-23837, doi:10.1109/ACCESS.2020.2968045.
Wirkuttis, N.; Klein, H. Artificial Intelligence in Cybersecurity. Cyber, Intell. Secur. 2017, 1, 103.
Rapid7 VSFTPD v2.3.4 Backdoor Command Execution Available online: www.rapid7.com/db/modules/exploit/unix/ftp/vsftpd_234_backdoor/(accessed on Feb. 20, 2022).
Rapid7 UnrealIRCD 3.2.8.1 Backdoor Command Execution Available online: www.rapid7.com/db/modules/exploit/unix/irc/unreal_ircd_3281_backdoor/(accessed on Feb. 20, 2022).
Kauppi, A.; Germain, B. Lua Lanes-multithreading in Lua Available online: lualanes.github.io/lanes/(accessed on Jan. 28, 2022).
Jovanovic, E. D.; Vuletic, P. V. Analysis and Characterization of IoT Malware Command and Control Communication. 27th Telecommun. Forum, TELFOR 2019 2019, doi: 10.1109/TELFOR48224.2019.8971194
Vogt, R.; Aycock, J.; Jacobson, M. J. J. Army of Botnets. In Proceedings of the Network and Distributed System Security Symposium; San Diego, California, 2007.
Calvet, J.; Davis, C. R.; Bureau, P. M. Malware authors don't learn, and that's good! 2009 4th Int. Conf. Malicious Unwanted Software, MALWARE 2009 2009, 88-97, doi:10.1109/MALWARE.2009.5403013.
Analytics, C. K., Battaglia, J. A., Miller, D. P., & Whitley, S. M. (2017). Finding Cyber Threats with ATT&CK™-Based Analytics. June.
Bartlett, G., Heidemann, J., & Papadopoulos, C. (2007). Understanding Passive and Active Service Discovery Categories and Subject Descriptors. Techniques, 57-70.
Bodeau, D., & Graubart, R. (2013). Intended effects of cyber resiliency techniques on adversary activities. 2013 IEEE International Conference on Technologies for Homeland Security, HST 2013, 7-11. doi.org/10.1109/THS.2013.6698967.
Bou-Harb, E., Debbabi, M., & Assi, C. (2014). Cyber scanning: A comprehensive survey. IEEE Communications Surveys and Tutorials, 16(3), 1496-1519. doi.org/10.1109/SURV.2013.102913.00020.
Brussel, H. Van, Moreas, R., Zaatri, A., & Nuttin, M. (1998). A Behaviour-Based Blackboard Architecture for Mobile Robots. 2162-2167.
Chau, K. W., & Albermani, F. (2005). A knowledge-based system for liquid retaining structure design with blackboard architecture. Building and Environment, 40(1), 73-81. doi.org/10.1016/j.buildenv.2004.05.005.
Ciampa, M. (2022). CompTIA Security+Guide to Network Security Fundamentals (M. Ciampa (ed.); Seventh Ed). Cengage.
Corkill, D. D. (1991 September). Blackboard Systems.
Dan Corkill Repository Website. Craig, I. D. (1988).
Blackboard systems. Artificial Intelligence Review, 2(2), 103-118.
Daimi, K. (2017). Computer and network security essentials. In Computer and Network Security Essentials. doi.org/10.1007/978-3-319-58424-9.
Detore, A. W., & Director, M. (1989). An Introduction to Expert Systems. Journal of Insurance Medicine, 21(4).
Dong, J., & Chen, S. (2015). Event-based blackboard architecture for multi-agent systems Event-Based Blackboard Architecture for Multi-Agent Systems. May 2005.
Erman, L. D., Hayes-Roth, F., Lesser, V. R., & Reddy, D. R. (1980). The Hearsay-II speech-understanding system: Integrating knowledge to resolve uncertainty. ACM Computing Surveys (CSUR), 12(2), 213-253.
Gade, K., Geyik, S. C., Kenthapadi, K., Mithal, V., & Taly, A. (2019 Aug. 4). Explainable AI in Industry. Proceedings of the 25th ACM SIGKDD International Conference on Knowledge Discovery & Data Mining. dl.acm.org/doi/abs/10.1145/3292500.3332281.
Godsmark, D., & Brown, G. J. (1999). Blackboard architecture for computational auditory scene analysis. Speech Communication, 27(3), 351-366. doi.org/10.1016/S0167-6393(98)00082-X.
Gunning, D., Stefik, M., Choi, J., Miller, T., Stumpf, S., & Yang, G. Z. (2019). XAI-Explainable artificial intelligence. Science Robotics, 4(37). doi.org/10.1126/scirobotics.aay7120.
Hai, T. (2017). Artificial Intelligence in Cybersecurity. 1(1), 103.
Hamet, P., & Tremblay, J. (2017). Artificial intelligence in medicine. Metabolism: Clinical and Experimental, 69, S36-S40. doi.org/10.1016/j.metabol.2017.01.011.
Kandpal, V., & Singh, R. K. (2013). Latest Face of Cybercrime and Its Prevention In India. International Journal of Basic and Applied Sciences Kandpal & Singh, 2(4), 150-156.
Khan, S., & Parkinson, S. (2018). Review into State of the Art of Vulnerability Assessment using Artificial Intelligence (Issue September). doi.org/10.1007/978-3-319-92624-7 1.
Lu, C., Jen, W., Chang, W., & Chou, S. (2006). Cybercrime & Cybercriminals: An Overview of the Taiwan Experience.
Lu, Y. (2019). Artificial intelligence: a survey on evolution, models, applications and future trends. Journal of Management Analytics, 6(1), 1-29. doi.org/10.1080/23270012.2019.1570365.
Patel, A., Qassim, Q., & Wills, C. (2010). A survey of intrusion detection and prevention systems. Information Management and Computer Security, 18(4), 277-290. doi.org/10.1108/09685221011079199.
Qiu, S., Liu, Q., Zhou, S., & Wu, C. (2019). Review of artificial intelligence adversarial attack and defense technologies. Applied Sciences (Switzerland), 9(5). doi.org/10.3390/aU.S. Plant U.S. Pat. No. 9,050,909.
Rubin, K. S., Jones, P. M., & Mitchell, C. M. (1988). OFMspert: Inference of operator intentions in supervisory control using a blackboard architecture. Systems, Man and Cybernetics, IEEE Transactions On, 18(4), 618-637.
Rubin, S. H., Smith, M. H., & Trajkovic, L. (2003). A blackboard architecture for countering terrorism. Systems, Man and Cybernetics, 2003. IEEE International Conference On, 2, 1550-1553.
Sadeh, N. M., Hildum, D. W., Laliberty, T. J., McA'nulty, J., Kjenstad, D., & Tseng, A. (1998). A blackboard architecture for integrating process planning and production scheduling. Concurrent Engineering Research and Applications, 6(2), 88-100. doi.org/10.1177/1063293X9800600201.
Samtani, S., Kantarcioglu, M., & Chen, H. (2020). Trailblazing the Artificial Intelligence for Cybersecurity Discipline: A Multi-Disciplinary Research Roadmap. ACM Transactions on Management Information Systems, 11(4). doi.org/10.1145/3430360.
Schwartz, J., & Kurniawati, H. (2019). Autonomous Penetration Testing using Reinforcement Learning.
Seo, H. S., & Cho, T. H. (2003). An application of blackboard architecture for the coordination among the security systems. Simulation Modelling Practice and Theory, 11(3-4), 269-284. doi.org/10.1016/S1569-190X(03)00061-3.
Shaikh, S. A., Chivers, H., Nobles, P., Clark, J. A., & Chen, H. (2008). Network reconnaissance. Network Security, 2008(11), 12-16. doi.org/10.1016/S1353-4858(08)70129-6.
Shivayogimath, C. N. (n.d.). AN OVERVIEW OF NETWORK PENETRATION TESTING.
Straub, J. (2015). Blackboard-based electronic warfare system. Proceedings of the ACM Conference on Computer and Communications Security, 2015-Octob. doi.org/10.1145/2810103.2810109.
Straub, Jeremy. (n.d.). Analysis of the Efficacy of the Addition of a Verifier to Blackboard Architecture Systems. Submitted to Expert Systems.
Straub, Jeremy. (2020). Modeling Attack, Defense and Threat Trees and the Cyber Kill Chain, ATT&CK and STRIDE Frameworks as Blackboard Architecture Networks. Proceedings-2020 IEEE International Conference on Smart Cloud, SmartCloud 2020, 148-153. doi.org/10.1109/SMARTCLOUD49737.2020.00035.
Straub, Jeremy. (2022). A modern Blackboard Architecture implementation with external command execution capability. Software Impacts, 11, 100183. doi.org/10.1016/J.SIMPA.2021.100183.
Straub, Jeremy. (2015). POSTER: Blackboard-Based Electronic Warfare System. Proceedings of the 22nd ACM SIGSAC Conference on Computer and Communications Security, 1681-1683.
Tundis, A., Mazurczyk, W., & Mühlhäuser, M. (2018). A review of network vulnerabilities scanning tools: Types, capabilities and functioning. ACM International Conference Proceeding Series. doi.org/10.1145/3230833.3233287.
Webster, S., Lippmann, R., & Zissman, M. (2006). Experience using active and passive mapping for network situational awareness. Proceedings—Fifth IEEE International Symposium on Network Computing and Applications, N C A 2006, 2006, 19-26. doi.org/10.1109/NCA.2006.23.
Weiss, M., & Stetter, F. (1992). A hierarchical blackboard architecture for distributed AI systems. Software Engineering and Knowledge Engineering, 1992. Proceedings., Fourth International Conference On, 349-355.
Wirkuttis, N., & Klein, H. (2017). Artificial Intelligence in Cybersecurity. 1(1), 103.
Yadav, T., & Rao, A. M. (2015). Technical Aspects of Cyber Kill Chain (pp. 438-452). Springer, Cham. doi.org/10.1007/978-3-319-22915-7 40.
Zakaria, M., Al-Shebany, M., & Sarhan, S. (2014). Artificial Neural Network: A Brief Overview. Journal of Engineering Research and Applications Ijera.Com, 4(2), 7-12.
Zawacki-Richter, O., Marin, V. I., Bond, M., & Gouverneur, F. (2019). Systematic review of research on artificial intelligence applications in higher education-where are the educators? International Journal of Educational Technology in Higher Education, 16(1). doi.org/10.1186/s41239-019-0171-0.
Zhang, Q., Zhou, C., Xiong, N., Qin, Y., Li, X., & Huang, S. (2016). Multimodel-Based Incident Prediction and Risk Assessment in Dynamic Cybersecurity Protection for Industrial Control Systems. IEEE Transactions on Systems, Man, and Cybernetics: Systems, 46(10), 1429-1444. doi.org/10.1109/TSMC.2015.2503399.

What is claimed:

1. A system for autonomous cybersecurity probing of a computing device or network, comprising:
processing circuitry; and
one or more storage devices comprising instructions, which when executed by the processing circuitry configure the system to conduct autonomous cybersecurity probing of a computing device or network.

2. The system of claim 1, comprising:
a computing device or network scanning module adapted to configure a target computing device or network scan and convert said scan to machine readable form, the scanning module further comprising an ingest module configured to process said scan to create nodes representative of the target computing device or network ports, port status, and vulnerabilities;
a command module comprising a plurality of nodes representing facts, rules, actions, and verifiers associated with one or more computing device or network vulnerabilities identified by the scanning module, said command module being configured to determine whether to launch an attack;
an attack module configured to, on receipt of instructions from the command module, assign an attack based on a one of the one or more computing device or network vulnerabilities; and
a verifier module configured to determine success or failure of the assigned attack and to return an indicator of the determined success or failure to the command module.

3. The system of claim 1, wherein the cybersecurity probing of the computing device or network is a vulnerability probing selected from one or more of a vulnerability identification, a vulnerability exploitation, and a vulnerability assessment.

4. The system of claim 1, wherein the attack module is provided the one of the one or more computing device or network vulnerabilities and a target IP address by the command module.

5. The system of claim 1, wherein the verifier module is provided the one of the one or more computing device or network vulnerabilities and a target IP address by the command module.

6. The system of claim 1, wherein the attack module and the verifier module are not configured to communicate one with the other.

7. The system of claim 1, wherein the ingest module creates said nodes representative of the target computing device or network ports, port status, and vulnerabilities within a Blackboard Architecture network.

8. The system of claim 1, wherein the scanning module is configured to convert an NMap computing device or network scan output to the machine-readable form.

9. The system of claim 5, wherein the attack module is configured to:
assign an attack according to the one of the one or more computing device or network vulnerabilities;
assign an attack script to implement against the target computing device or network, the attack script defining a corresponding attack; and
execute the assigned attack using the assigned attack script.

10. The system of claim 5, wherein the verifier module is configured to:
select a verification method according to the provided one of the one or more computing device or network vulnerabilities and the target IP address;
verify a success of the assigned attack.

11. The system of claim 10, wherein the verification method is one of determining whether an expected change has been made to the target computing device or network or determining whether the target computing device or network is operational.

12. The system of claim 10, wherein the verifier module is selected from one or more of the group consisting of: a triggered verifier, a specific date/time verifier, a time in the future verifier, and a data expiration verifier.

13. The system of claim 2, wherein the command module is configured using a Blackboard Architecture comprising:
facts which are values defining target computing device or network information selected from the group consisting of host information, port information, computing device or network vulnerability information, an identification field, and a description field;
rules which are triggered when all facts identified as necessary pre-conditions to an action are determined to be true;
actions which are triggered by rules to perform a task; and
verifiers which verify whether an action was successful.

14. A computer-implemented method for autonomous cybersecurity probing of a computing device or network, comprising:
by a computing device or network scanning module adapted to configure a target computing device or network scan and convert said scan to machine readable form, the scanning module further comprising an ingest module configured to process said scan, creating within a Blackboard Architecture nodes representative of the computing device or network system, ports, port status, and vulnerabilities;
by a command module comprising a plurality of nodes representing facts, rules, actions, and verifiers associated with one or more computing device or network vulnerabilities identified by the scanning module, said command module being configured to determine whether to launch an attack, providing a one of the one or more computing device or network vulnerabilities and a target IP address to an attack module configured to, on receipt of instructions from the command module, assign an attack based on the one of the one or more computing device or network vulnerabilities; and
by the command module, providing the one of the one or more computing device or network vulnerabilities and a target IP address to a verifier module configured to determine success or failure of the assigned attack and to return an indicator of the determined success or failure to the command module.

15. The system of claim 14, wherein the cybersecurity probing of the computing device or network is a vulnerability probing selected from one or more of a vulnerability identification, a vulnerability exploitation, and a vulnerability assessment.

16. The method of claim 14, including configuring the attack module and the verifier module whereby they do not communicate one with the other.

17. The method of claim 14, including configuring the scanning module to convert an NMap computing device or network scan output to the machine-readable form.

18. The method of claim 14, including configuring the attack module to:
assign an attack according to the one of the one or more computing device or network vulnerabilities;
assign an attack script to implement against the target computing device or network, the attack script defining a corresponding attack; and
execute the assigned attack using the assigned attack script.

19. The method of claim 14, including configuring the verifier module to:
select a verification method according to the provided one of the one or more computing device or network vulnerabilities and the target IP address; and
verify a success of the assigned attack.

20. The method of claim 19, including configuring the verification module to select a verification method from one of determining whether an expected change has been made to the target computing device or network or determining whether the target computing device or network is operational.

21. The method of claim 14, including selecting the verifier module from one or more of the group consisting of: a triggered verifier, a specific date/time verifier, a time in the future verifier, and a data expiration verifier.

22. The method of claim 14, including configuring the command module is using a Blackboard Architecture comprising:
facts which are values defining target computing device or network information selected from the group consisting of host information, port information, computing device or network vulnerability information, an identification field, and a description field;
rules which are triggered when all facts identified as necessary pre-conditions to an action are determined to be true;
actions which are triggered by rules to perform a task; and
verifiers which verify whether an action was successful.
